(19) United States
(12) Patent Application Publication
(10) Pub. No.: US 2015/0128121 A1
(43) Pub. Date: May 7, 2015

(54) DYNAMIC APPLICATION VERSION SELECTION

(71) Applicant: Improvement Interactive, LLC, Tucson, AZ (US)

(72) Inventor: Frank Anthony Garcia, Tucson, AZ (US)

(21) Appl. No.: 14/534,923

(22) Filed: Nov. 6, 2014

Related U.S. Application Data
(60) Provisional application No. 61/900,613, filed on Nov. 6, 2013.

(51) Int. Cl. G06F 9/445; G06F 9/44

(52) U.S. Cl. CPC G06F 8/65; G06F 8/71
USPC 717/170

(57) ABSTRACT

It is to be understood that both the following general description and the following detailed description are exemplary and explanatory only and are not restrictive. In an aspect, the methods and systems of the present disclosure can relate to managing data via a network. As an example, the network can be a local area network, a wide area network (e.g., the Internet), or other network of devices. In another aspect, the methods and system of the present disclosure can relate to a holographic web service (serving). As an example, the holographic web serving allows developers to code applications for a single web server using standard web requests (e.g., GET, POST, etc.). Such code can execute (run) as is, both in a local environment and in complex cloud environments. As another example, operators of a holographic cloud environment not only have the flexibility to scale the application as needed, but can have multiple versions of the application running at the same time. Operators are also able to specify one or more of a plurality of servers and processes to handle particular requests. As such, developers do not need to be concerned with, code for, or even know about load balancers, message buses, or workers.

### CROSS REFERENCE TO RELATED PATENT APPLICATION

This application claims priority to U.S. Provisional Application No. 61/900,613 filed Nov. 6, 2013, herein incorporated by reference in its entirety.

### BACKGROUND

As the variety of web user segmentation and web client devices proliferates, web developers are often required to implement different versions of applications to support capabilities of various devices. As an example, a developer may be required to know the specific capabilities of the client architecture in order to develop the application for such specific capabilities. These and other shortcomings are addressed by the present disclosure.

### SUMMARY

It is to be understood that both the following general description and the following detailed description are exemplary and explanatory only and are not restrictive. In an aspect, the methods and systems of the present disclosure can relate to managing data via a network. As an example, the network can be a local area network, a wide area network (e.g., the Internet), or other network of devices. In another aspect, the methods and system of the present disclosure can relate to a holographic web service (serving). As an example, the holographic web serving allows developers to code applications for a single web server using standard web requests (e.g., GET, POST, etc.). Such code can execute (run) as is, both in a local environment and in complex cloud environments. As another example, operators of a holographic cloud environment not only have the flexibility to scale the application as needed, but can have multiple versions of the application running at the same time. Operators are also able to specify one or more of a plurality of servers and processes to handle particular requests. As such, developers do not need to be concerned with, code for, or even know about load balancers, message buses, or workers.

In an aspect, a method can comprise providing a holographic deployment to facilitate a plurality of versions of an application to reside on a server, automatically updating an application version number associated with one or more versions of the plurality of versions of the application, and loading a file associated with the application based on the updated application version number, wherein a file name and a reference to the file is updated based on the updated version number. In an aspect, a holographic deployment can comprise all of the plurality of versions of the application residing on each server, even though each server may host one of the plurality of versions of the application.

In an aspect, a method can comprise providing a servicing framework based on asynchronous messaging operations, wherein the messaging operations include a message version and an application version and routing one or more messages for a particular application version in accordance with the servicing framework, wherein the servicing framework facilitates a plurality of versions of an application to reside on a server.

In an aspect, a method can comprise receiving an application specific message at a web server; routing the application specific message via a message bus to one or more of a worker and a long worker, wherein the one or more of the worker and the long worker is configured to process dynamic content for a particular version of an application associated with the application specific message; processing the application specific message via the one or more of the worker and the long worker to generate a response to the application specific message.

In accordance with the methods and systems disclosed herein, one or more computing devices can receive a first request for a resource from a client device. In an aspect, the resource can be associated with a plurality of version numbers. In an aspect, the first request can comprise first user credentials. In an aspect, the one or more computing devices can determine that a first version type is associated with the first user credentials. In an aspect, the first request can comprise a cookie. In an aspect, the one or more computing devices can determine that a first version type is associated with the cookie. In an aspect, the one or more computing devices can determine a version number of the plurality of version numbers is associated with the first determined version type. In an aspect, the one or more computing devices can respond to the received first request based on the determined version number.

In accordance with the methods and systems disclosed herein, a first request for a resource can be transmitted from a client device. In an aspect, the first request can comprise first user credentials. In an aspect, a first type can be determined based on the first user credentials. In an aspect, a version of the resource is determined based on the first determined type. In an aspect, the determined version of the first requested resource can be received. In an aspect, the resource can appear versionless to the client device.

In accordance with the methods and systems disclosed herein, a framework can be provided to facilitate a plurality of versions of an application to reside on a server. In an aspect, each of the plurality of versions of the application can be associated with an application version number. In an aspect, a first request to compile the application can be received. In an aspect, an application version number can be created based on the first received request. In an aspect, a file associated with the application can be loaded based on the created application version number. In an aspect, a file name and a reference to the file can be updated based on the created version number.

In accordance with the methods and systems disclosed herein, a computing device can receive an application. In an aspect, the application can comprise one or more versions. In an aspect, one or more of the versions of the application can be combined into a single package. In an aspect, a unique identifier can be assigned to each of the one or more combined versions of the application.

In accordance with the methods and systems disclosed herein, a program can be provided. In an aspect, the program can provide an application. In an aspect, one or more versions of the application can be combined into a single package. In an aspect, one or more servers can be utilized to serve requests for the one or more versions of the application. A request associated with one of the one or more versions of the application can be received. The request can be responded to.

In accordance with the methods and systems disclosed herein, a cloud computing environment can be provided. In an aspect, one or more versions of an application can be uploaded and combined into a single package. In an aspect, the single package can be provided to one or more servers. A request can be received for one of the one or more versions of the application. One of the one or more servers can be selected. In an aspect, the selected server can be configured to serve the requested version of the application. The request can be routed to the selected server.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1A is a block diagram of an exemplary system;

FIG. 1B is a block diagram of an exemplary system;

FIG. 2 illustrates exemplary active versions configuration;

FIG. 3 illustrates packaging examples;

FIG. 4 illustrates packaging examples;

FIG. 5 illustrates packaging examples;

FIG. 6 illustrates packaging examples;

FIG. 7 illustrates packaging examples;

FIG. 8A illustrates an exemplary homogeneous deployment:

FIG. 8B illustrates an exemplary homogeneous deployment;

FIG. 9 illustrates an exemplary homogeneous deployment;

FIG. 10 illustrates an exemplary homogeneous deployment;

FIG. 11 illustrates an exemplary mixed deployment;

FIG. 12 illustrates an exemplary mixed deployment;

FIG. 13 illustrates an exemplary hybrid deployment;

FIG. 14 illustrates an exemplary hybrid deployment;

FIG. 15 illustrates an exemplary method flow;

FIG. 16 illustrates an exemplary method flow;

FIG. 17 illustrates an exemplary method flow;

FIG. 18 illustrates an exemplary method flow;

FIG. 19 illustrates an exemplary method flow;

FIG. 20 illustrates an exemplary method flow;

FIG. 21 illustrates an exemplary method flow;

FIG. 22 illustrates an exemplary method flow;

FIG. 23 illustrates an exemplary method flow;

FIG. 24 illustrates an exemplary method flow;

FIG. 25 illustrates an exemplary method flow;

FIG. 26 illustrates an exemplary method flow;

FIG. 27 illustrates an exemplary method flow;

FIG. 28 illustrates an exemplary method flow;

FIG. 29 illustrates an exemplary method flow;

FIG. 30 illustrates an exemplary method flow;

FIG. 31 illustrates an exemplary method flow;

FIG. 32 illustrates an exemplary method flow;

FIG. 33 illustrates an exemplary method flow;

FIG. 34 illustrates an exemplary method flow;

FIG. 35 illustrates an exemplary method flow;

FIG. 36 illustrates an exemplary method flow;

FIG. 37 illustrates an exemplary method flow;

FIG. 38 illustrates an exemplary method flow;

FIG. 39 illustrates an exemplary method flow;

FIG. 40 illustrates an exemplary method flow;

FIG. 41 illustrates an exemplary method flow;

FIG. 42 illustrates an exemplary method flow;

FIG. 43 illustrates an exemplary method flow;

FIG. 44 illustrates an exemplary method flow;

FIG. 45 illustrates an exemplary method flow;

FIG. 46 illustrates an exemplary data flow;

FIG. 47 illustrates an exemplary data flow;

FIG. 48 is a block diagram of an exemplary system;

FIG. 49 is an exemplary database table;

FIG. 50 is an exemplary database table;

FIG. 51 is an exemplary database table;

FIG. 52 is a block diagram of an exemplary system;

FIG. 53 is a block diagram of an exemplary system;

FIG. 54 is an exemplary user interface;

FIG. 55 is a block diagram of an exemplary system;

FIG. 56 is a block diagram of an exemplary system;

FIG. 57 is a block diagram of an exemplary system;

FIG. 58 is an exemplary user interface;

FIG. 59 is an exemplary flowchart;

FIG. 60 is an exemplary flowchart;

FIG. 61 is an exemplary flowchart;

FIG. 62 is an exemplary flowchart;

FIG. 63 is an exemplary flowchart; and

FIG. 64 is an exemplary flowchart.

### DETAILED DESCRIPTION

Before the present methods and systems are disclosed and described, it is to be understood that the methods and systems are not limited to specific methods, specific components, or to particular configurations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises.” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed, while specific reference of each various individual and collective combination and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

In an aspect, the methods and system of the present disclosure can relate to managing data via a network. As an example, the network can be a local area network, a wide area network (e.g., the Internet), or other network of devices. In another aspect, the methods and system of the present disclosure can relate to a holographic web service (serving). As an example, the holographic web serving allows developers to code applications for a single web server using standard web requests (e.g., GET, POST, etc.). Such code can execute (run) as is, both in a local environment and in complex cloud environments. As another example, operators of a holographic cloud environment not only have the flexibility to scale the application as needed, but can have multiple versions of the application running at the same time. Operators are also able to specify one or more of a plurality of servers and processes to handle particular requests. As such, developers do not need to be concerned with, code for, or even know about load balancers, message buses, or workers.

In an aspect, a holographic build process enables enhanced caching techniques of client resources. Such enhanced caching can remove the need for the client to check for newer versions of one or more resources, significantly, at times dramatically, increasing the performance of web applications.

In an aspect, holographic web serving can be enabled by taking a version of a web application's files and transforming associated names (identifiers) to contain the current version number of the application. References in the transformed filenames can be updated in all files of the application. Transformations may not necessarily occur in place. As an example, files can be copied and transformed (renamed) into the version package directory which is named for the version number.

Once built, individual application version packages can be combined into a holographic web server package. One or more packages can be deployed to servers, as appropriate. Once packages are deployed, users access and use the version or versions of the application associated with the deployed package(s). The use of application versions can be transparent to users. Users can continue to navigate to and bookmark identifiers (e.g., URLs) associated with the application(s).

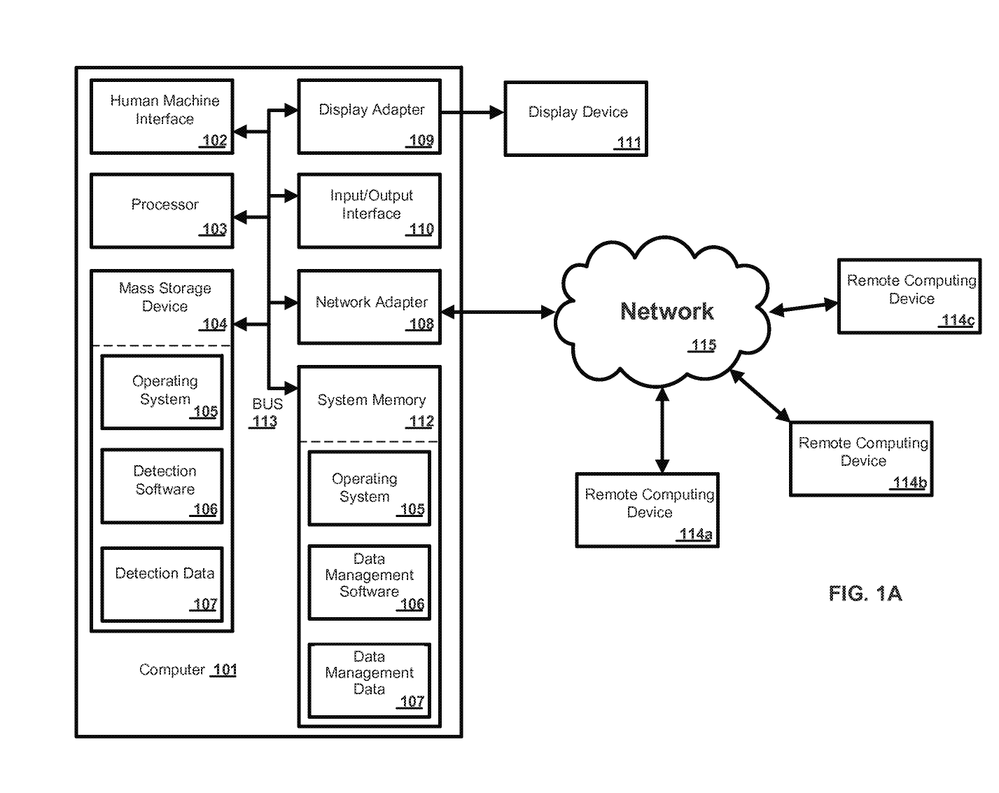

FIG. 1A is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, data management software 106, data management data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, as non-limiting examples, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as data management data 107 and/or program modules such as operating system 105 and data management software 106 that are immediately accessible to and/or are presently operated on by the processing unit 103.

In another aspect, the computer 101 can also comprise other removable/non-removable, volatile/non-volatile computer storage media. By way of example, FIG. 1A illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and data management software 106. Each of the operating system 105 and data management software 106 (or some combination thereof) can comprise elements of the programming and the data management software 106. Data management data 107 can also be stored on the mass storage device 104. Data management data 107 can be stored in any of one or more databases known in the art. Examples of such databases comprise, DB2®, Microsoft® Access, Microsoft® SQL Server, Oracle®, MySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of data management software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning. Bayesian networks, behavior based AI, neural networks, fuzzy systems, evolutionary computation (e.g. genetic algorithms), swarm intelligence (e.g. ant algorithms), and hybrid intelligent systems (e.g. expert inference rules generated through a neural network or production rules from statistical learning).

FIG. 1B illustrates an exemplary holographic web serving process.

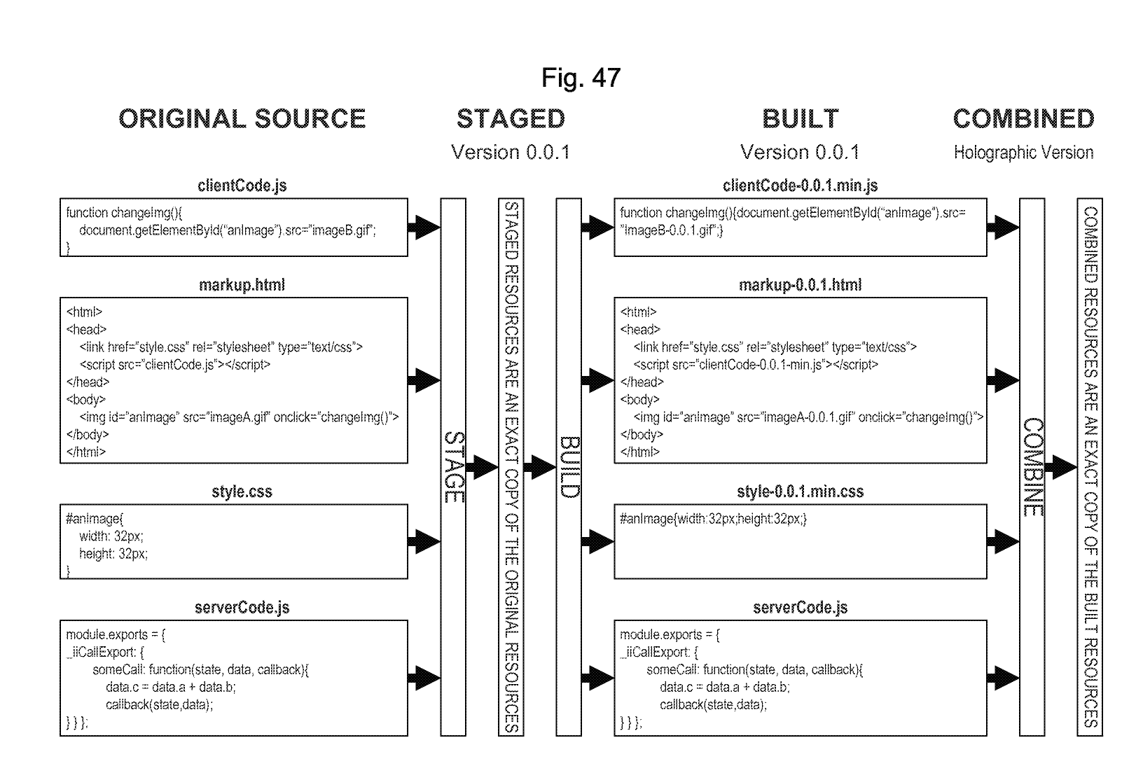

The process of FIG. 1B can comprise application resource sources (FIG. 47). In an aspect, source files can be located in a repository, a developer's local directory, a previously staged version directory, or a combination thereof. Source files can comprise any type of resource, including binary and executable images. Source files can comprise client-side, server-side code, or other resources.

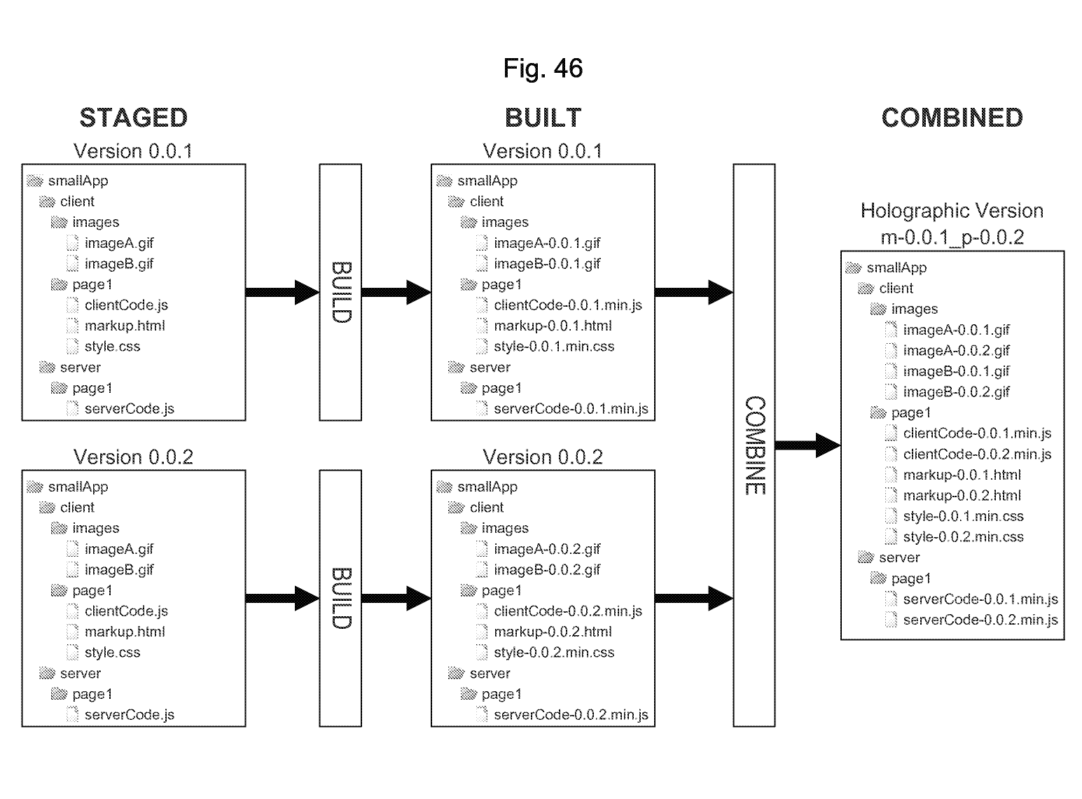

The process of FIG. 1B can comprise processes relating to acquiring and staging (FIGS. 46-47). Acquiring and staging can comprise copying files from a source location (e.g., a source code repository or developer directory) to a version numbered directory. When retrieving files from a repository, a filter can be applied to retrieve only the files associated with a particular version of the application. As an example, such a filter can take the form of a branch or particular commit. As a further example, previously staged versions do not need to be acquired and staged again.

The process of FIG. 1B can comprise staged versions of data (e.g., files) (FIGS. 46-47). Staged files can be unmodified from the source. In an aspect, staged files can represent a snapshot of the application at a point in time. In another aspect, staged files can be associated with a version of the application by the naming convention of the staging directory, which can comprise the version number of the application designated during staging. Staged files can be maintained for all current versions such that a particular version can be rebuilt. In a further aspect, staged versions that are no longer needed can be deleted.

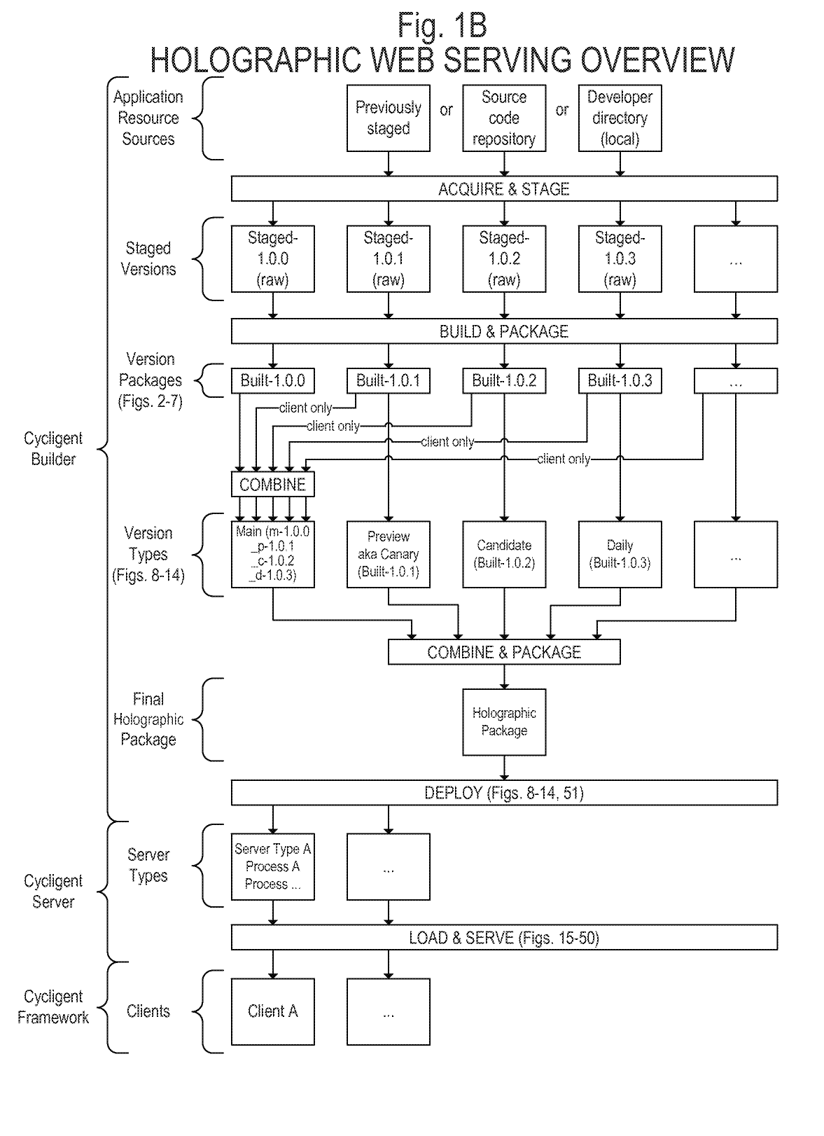

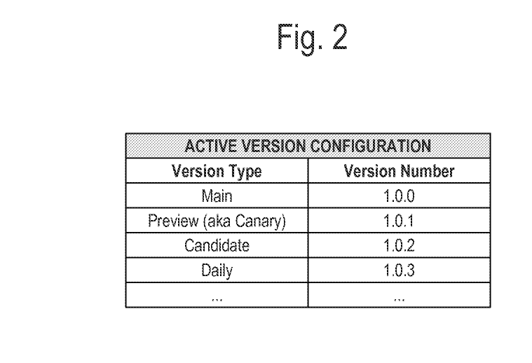

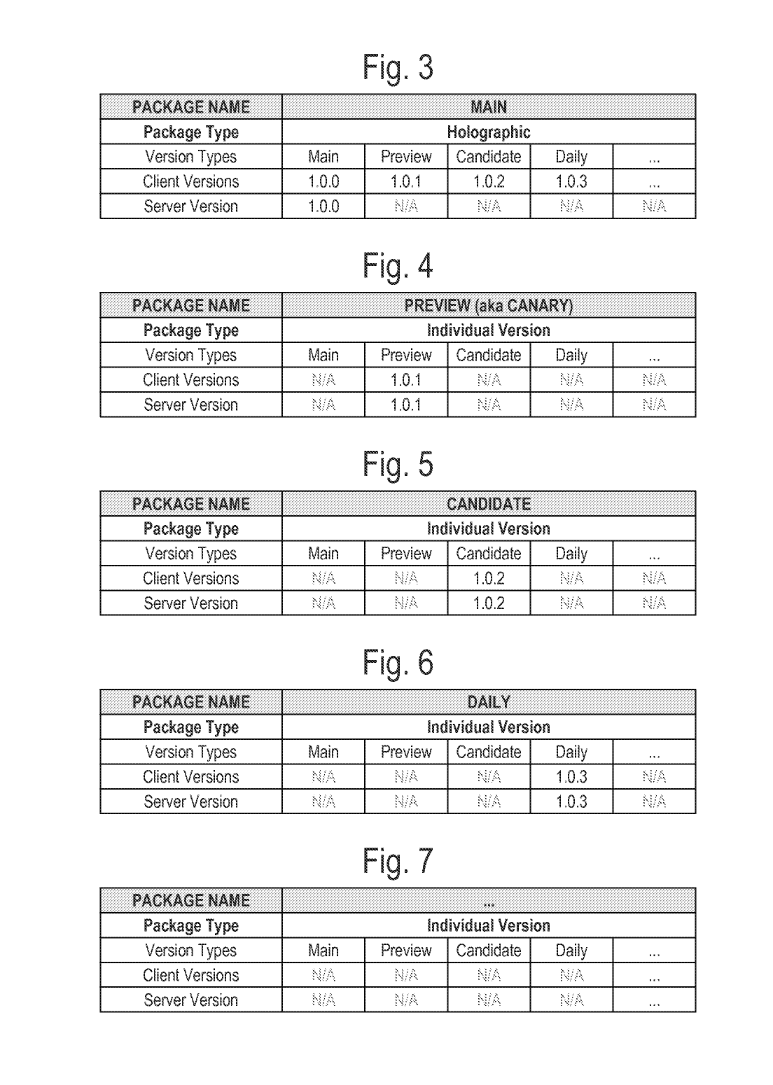

The process of FIG. 1B can comprise processes relating to building and packaging (FIGS. 2-7 and FIGS. 46-47). In an aspect, staged versions can be built. As an example, the build process can comprise copying and transforming files from the staging directory for a particular application version to a package directory for that particular application version. As a further example, while copying, all client-side content can be modified. In another aspect, files can be renamed to include the version number and references to the files can be updated. In a further aspect, the build process can optionally optimize content by minimizing content where appropriate and can indicate such optimization with a modification of the associated file name. As an example, a filename of myFile.js can be transformed to be myFile-1.7.12.js and, if optimized, can become myFile-1.7.12.min.js.

In an aspect, server-side resources (other than those in the _clientTextFunctions directory), are not transformed (renamed, combined or optimized). As an example, optimization can be unnecessary, as server-side resources are not transmitted over the Internet. Server-side resources for different versions of an application are typically run on separate servers, but can be run on the same server in different processes.

In an aspect, a _clientTextFunctions directory can comprise server-side code that is called from static content files, such as HTML files, to place dynamic content into those files when such files are served. In certain aspects, the filenames in _clientTextFunctions are not updated, but references to changed client filenames are updated. Server-side code that is running on its own server (or process) combined with the holographic web server's ability to route requests to the appropriate server-side code set for a particular version can reduce the need to modify any server-side resources (other than the references to client-side filenames in _clientTextFunctions). Because each file contains the version number, clients may cache the files indefinitely. When a new version is deployed, the names of the files can be changed and the new files can be loaded (e.g., HTML key enables enhanced caching.) In another aspect, including the version in the filename allows the files to remain in the same directory, allowing bookmarks to work normally.

In an aspect, building and packaging does not alter the behavior of the source files because the build process only renames files, updates references to those files, and minimizes files. The original files and the built files can behave in exactly the same manner, but the built files can be capable of being combined into holographic images, whereas, the original files may not be combinable into holographic images.

Since the behavior of the original source files and the built files can be the same, developers can have confidence that the code they debugged and tested on their machines will behave in the same manner on the server. Developers can code against a single instance of a server running on a local device. Holographic processing can then allow such developed code to behave the same way in complex cloud environments.

The process of FIG. 1B can comprise version packages (FIGS. 46-47). Version packages can comprise one or more built files for a particular application version. In an aspect, version packages can be maintained for one or more (or all) current versions. Version packages that are no longer needed can be deleted. Version packages can be holographic-ready because their associated filenames have been transformed. Version packages may not be holographic, however, as they only contain the files associated with one version of the application.

The process of FIG. 1B can comprise processes relating to a combine feature (FIGS. 46-47). Version packages can be suitable for deployment into environments that only support a single version. For environments that require multiple versions to be running simultaneously, a holographic package can be created via a combine process. Holographic packages can be created by combining one or more (or all) of the client-side resources, of one or more (or all) active versions of an application, into a single package. In a further aspect, this package can comprise the server-side resources for a main named version of the application.

The process of FIG. 1B can comprise one or more version types (FIG. 2). Version types can allow a conceptual version to be assigned to a server or user. Any number of version types can be configured. As an example, default version types can comprise main, preview, candidate, and daily. Other types can be included. As a further example, a preview version type can be synonymous with the industry term “canary.” As another further example, a version type can be named “flux.” In an aspect, because servers and users are assigned a conceptual version type, server configurations may not need to be updated as new versions come along. Instead, when a configuration object that associates application version numbers to conceptual version types is updated by the holographic build process during a build and deploy cycle, users and servers can be seamlessly moved to the new versions associated with the version type.

In an aspect, the main version type can be a current production version. The main version can comprise a holographic package in environments that support multiple concurrent versions. As an example, the holographic package can be deployed to one or more web servers (e.g., associated with the environments).

In an aspect, the preview version type, also known as a canary version (or deployment), can be the next production version of the software that a certain subset of users are assigned to use. Such assigned users can become an ad hoc group, and often unwitting, testing group that provide a final test of an application in the actual production environment before the application version is released to full production (e.g., main version).

In an aspect, the candidate version type can represent the last successfully tested version that can become the next main or preview version. The candidate version type can be separated so that other test builds do not impact the version. As an example, a candidate version type can run in the production environment to allow for testing and review.

In an aspect, the daily version type can be the latest build (e.g., performed periodically such as daily or more frequently), that is being analyzed. The daily version can run in the production environment.

In an aspect, version types can be isolated. While static client-side content can be combined into a holographic package for deployment, server-side content may not be combined and can be unmodified. This, along with the fact that static resources can be uniquely renamed using the version number of the application, can isolate the versions. As an example, versions may not affect one another. As such, candidate and daily builds may be run in the same cloud environment as production versions.

In an aspect, the design decision to run server-side code on separate servers can reduce the risk of version interaction. Even if a particular version was to take down a server, it would not affect the other versions. In another aspect, each version's database connections can be configurable. Such configurability can allow the option of isolating the databases for each version. With the latest no SQL database technologies, however, this may no longer be desirable as the documents within a single database can be versioned.

The process of FIG. 1B can comprise process combining the one or more version types into one holographic package.

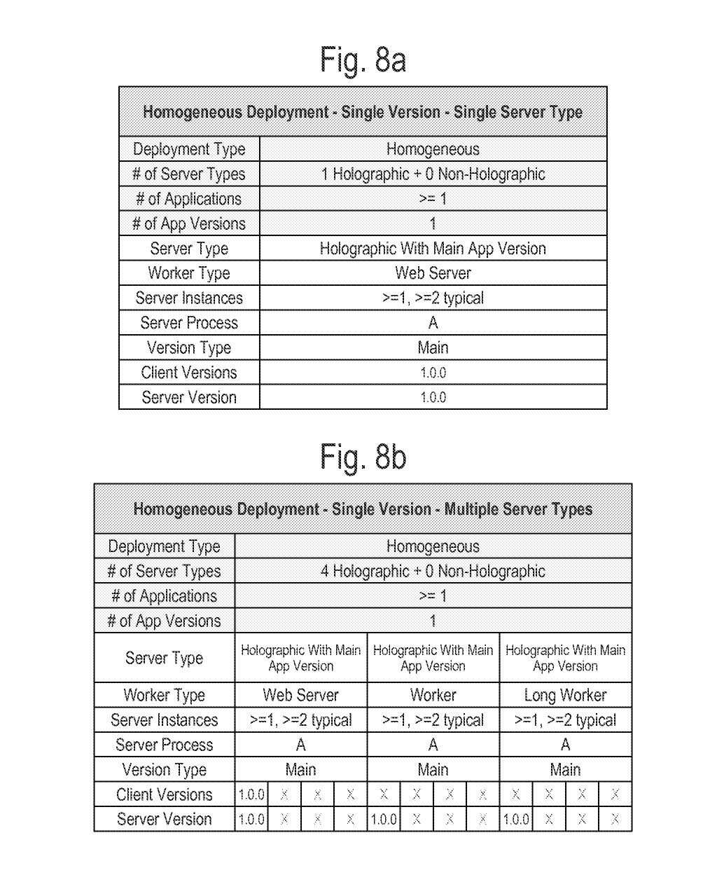

The process of FIG. 1B can comprise processes relating to one or more deployments (FIG. 8a-14). Deploying can be the process of copying packages to servers. In an aspect, deployments can be made to three types of environments: homogeneous, mixed, and hybrid. In another aspect, a single package can be deployed to a single server. However, other deployments can be made. Servers can be configured to run multiple versions in separate processes. When so configured, the versions a server serves can be deployed to that server in separate directory structures.

In an aspect, a deployment can comprise multiple load balanced server processes. In another aspect, load balanced environments can comprise multiple instances of a given server type. As an example, a server type can comprise a web server, worker, or long worker. In an aspect, a long worker can be a server dedicated to a process which exceeds a time threshold. In an aspect, a worker can be a server dedicated to a process which does not exceed the time threshold. In another aspect, a worker can be a server dedicated to a process without considering the time threshold. Deployments to additional instances of a given server within a given server type can be identical to the first instance. The deployment process can implement a rolling strategy so that applications suffer no downtime due to deployment when more than a single server is present for each server type.

In an aspect, servers that provide server-side functionality can be designated as worker and/or long worker instances. The deployments to these designated servers can be the same, but the servers can process different requests. Servers are capable of serving more than one application.

In an aspect, a deployment can be to a homogeneous environment. Homogeneous environments can be environments in which one or more (or all) servers are holographic capable servers. In these environments web servers can comprise all static client-side content. In single version deployments the individual version package can be deployed. In single version deployments, there is only one version and, therefore, a holographic package can be unnecessary. The package contains both client-side and server-side resources which can be deployed to a single process on the server. While a holographic package can be unnecessary, holographic web serving may still be used to facilitate the use of multiple server types. Multiple server types may be used in single version environments to separate workloads or offload work from web servers. For instance, long running reports might be designated to execute on long workers, ensuring that web servers remain responsive.

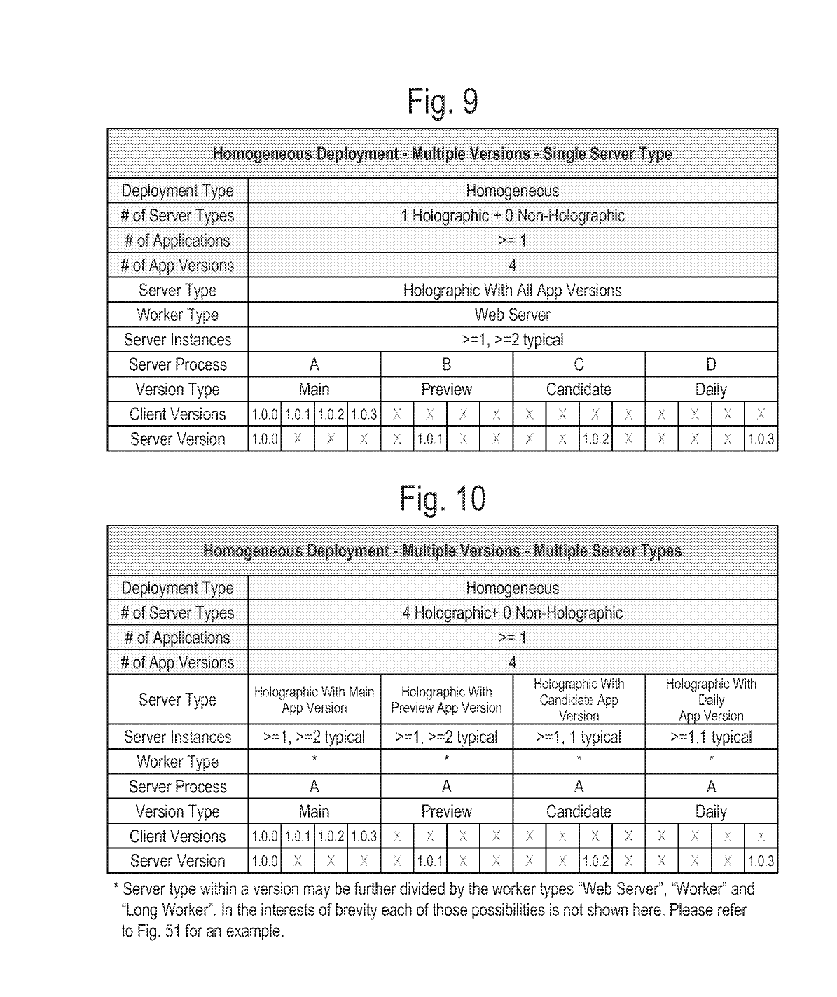

FIG. 9 illustrates a table relating to a single server type deployment for a homogeneous environment. Multiple version, single server type deployments can be the same as multiple version, multiple server type deployments except that instead of separate servers, the various versions can be run in separate processes and the packages for the various versions on the server can be isolated in their own directory structures. Multiple versions can be deployed on a single server. For example, the multiple versions can be deployed in separate directories and running as separate server processes. Multiple versions can be useful for testing and debugging. This can be true when only a single server instance is used, such as on a developer's machine.

FIG. 10 illustrates a table relating to a multiple server type deployment for a homogeneous environment. In multiple version, multiple server type deployments, a holographic package containing all client-side resources for all application versions, can be deployed to one or more (or all) web servers. The server-side resources for the main application version can also be deployed to the web servers. Other servers can be deployed the individual application version package, specifically server-side resources, for the version which they serve.

In an aspect, deployments can be made to mixed environments. Mixed environments can be environments in which servers other than holographic servers are used, such as Java, .NET, Ruby, Python, or Perl servers. In mixed environments the holographic servers can act only as authentication and proxy devices. The other server types can deliver all client-side and server-side functionality. In another aspect, holographic servers can authenticate a user and/or accept a cookie and then, based on the version configured for the user and/or the cookie and on the URL of the request, the holographic server can act as a proxy, forwarding the request to the server that will handle the request, waiting for that server to respond and then returning that response to the requestor.

FIG. 11 illustrates a table relating to single application version deployments for a mixed environment. Single application version deployments in mixed environments can be the same as multiple concurrent application deployments except only a single server type may be needed, other than the holographic server type, as there can be only a single application version.

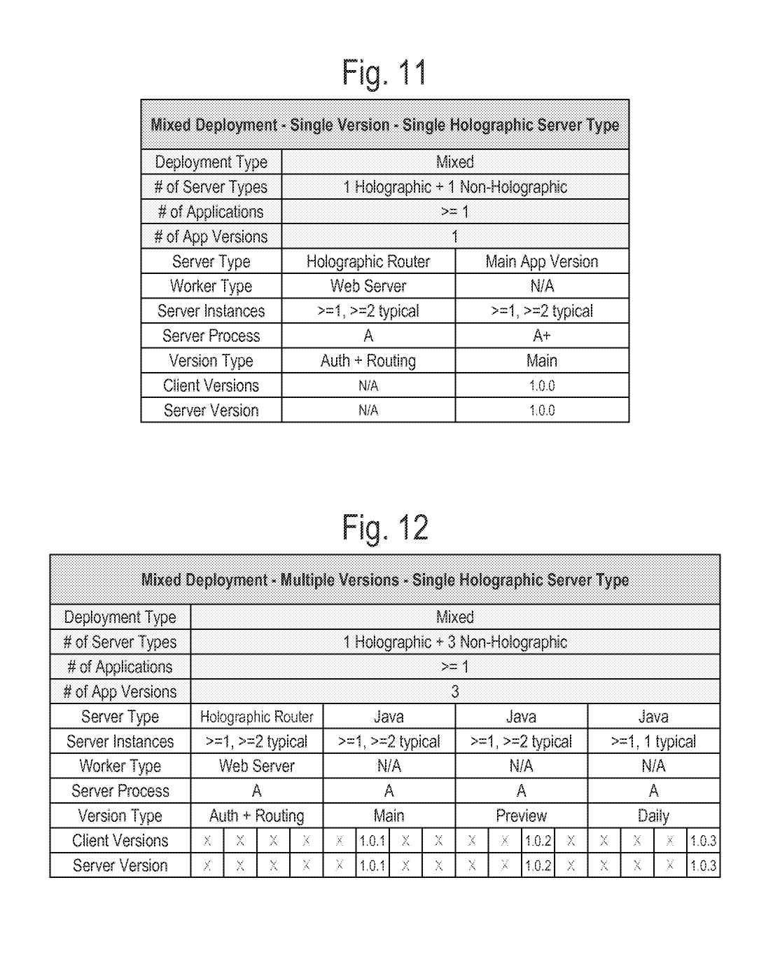

FIG. 12 illustrates a table relating to multiple concurrent application deployments for a mixed environment. In mixed environments, for example, multiple concurrent application deployments can be enabled by having one or more servers serve each of the application versions and having one or more holographic servers provide authentication and routing services. In multiple concurrent application deployments, base holographic server functionality can be deployed to the outwardly facing web servers. No application resources can be placed on the holographic servers. For other server types, application packaging (which includes all client-side and server-side resources) and package deployment can be made in a fashion consistent with their normal operation.

In an aspect, hybrid environments can utilize holographic servers to serve all client-side resources and non-holographic servers to serve all server-side functionality. In an aspect, a holographic server can be a server on which all versions of an application can reside. In hybrid environment deployments, base holographic server functionality is deployed to the outwardly facing web servers. Client-side, not server-side, application resources are placed on the holographic servers. For other servers, application packaging, which includes all client-side and server-side resources, and package deployment is made in a fashion consistent with their normal operation.

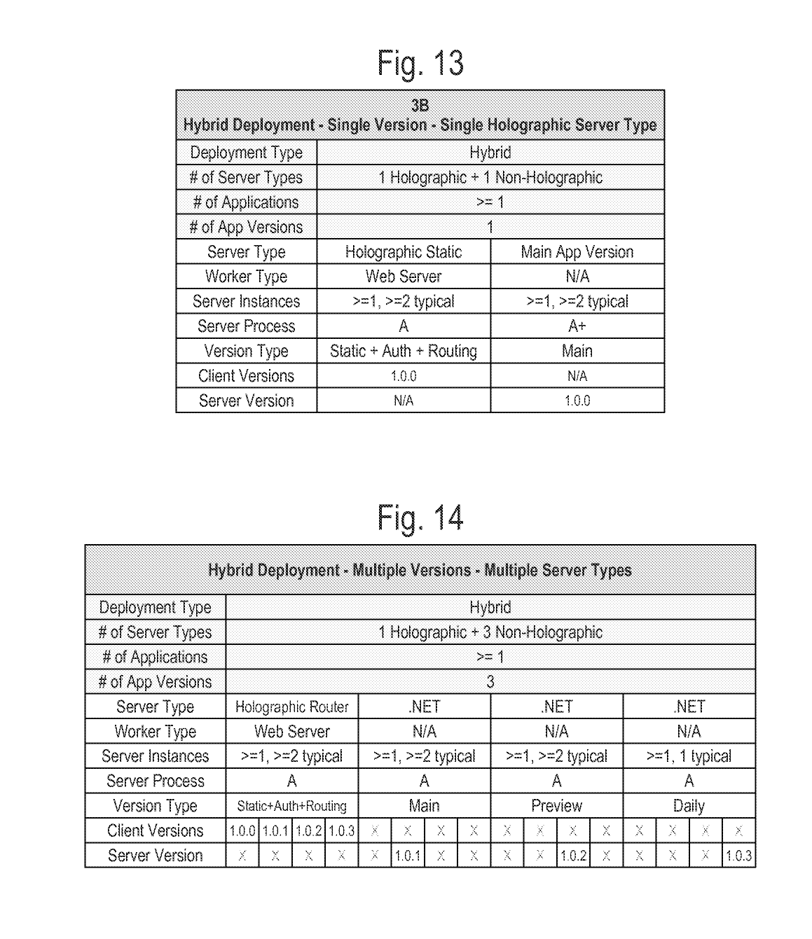

FIG. 13 illustrates a table relating to single application version deployments for a hybrid environment. Hybrid environments can handle single application version deployments the same as mixed environments except that an individual version package of client-side resources can be deployed to the holographic web servers. In an aspect, server-side code is not deployed to the web servers in a hybrid environment.

FIG. 14 illustrates a table relating to multiple concurrent application deployments for a hybrid environment. Hybrid environments can handle multiple application version deployments the same as mixed environments except that a holographic package of client-side resources can be deployed to the holographic web servers. In an aspect, server-side code is not be deployed to the web servers in a hybrid environment unless part of the hybrid environment is to use holographic server-side functionality.

In an aspect, the holographic system can recognize four types of servers: web, worker, long worker, and external. External servers (or systems) are typically other types of web servers, such as Java, .NET, Ruby, Python, Perl, etc. The internal server types (e.g., “Web,” “Worker,” and “Long Worker”) can include the application version as part of their type. “Worker” may not be sufficient to designate a server type as it does not include the version. In an aspect, “Worker-1.7.12” can be used to designate a server type and, thus, the set of servers that handle a particular type of request. In an aspect, a server can serve a single version of an application. When a server serves multiple application versions, each version can be served out of a separate process. These processes can look to the rest of the holographic system to be complete “virtual” servers and can be treated as such. In addition to the version and worker type, the granularity of server typing may be further increased by request type and criteria. In an aspect, the designation of “Worker-1.7.12” could further comprise a specified sub-type (which correlates directly to the message bus's sub-channel), such as “Call.” In a further aspect, the call criteria can be specified, such as “Call:myCall,” in which case only the specified calls would be handled.

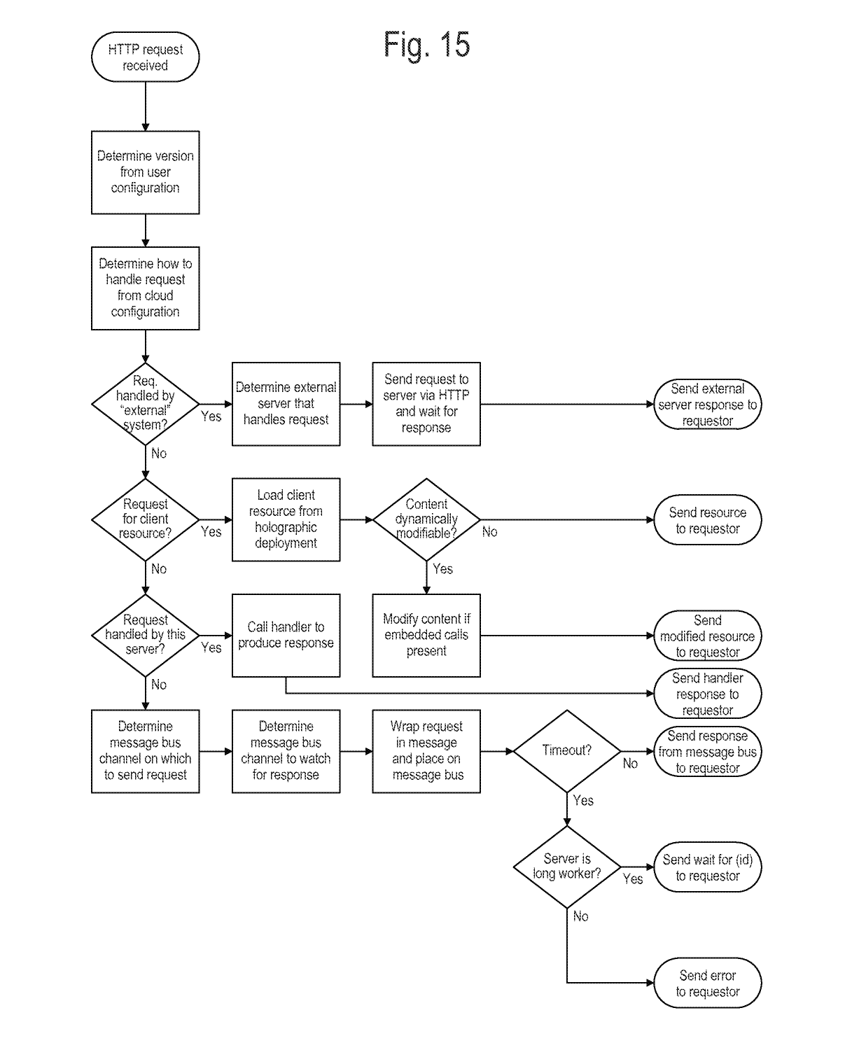

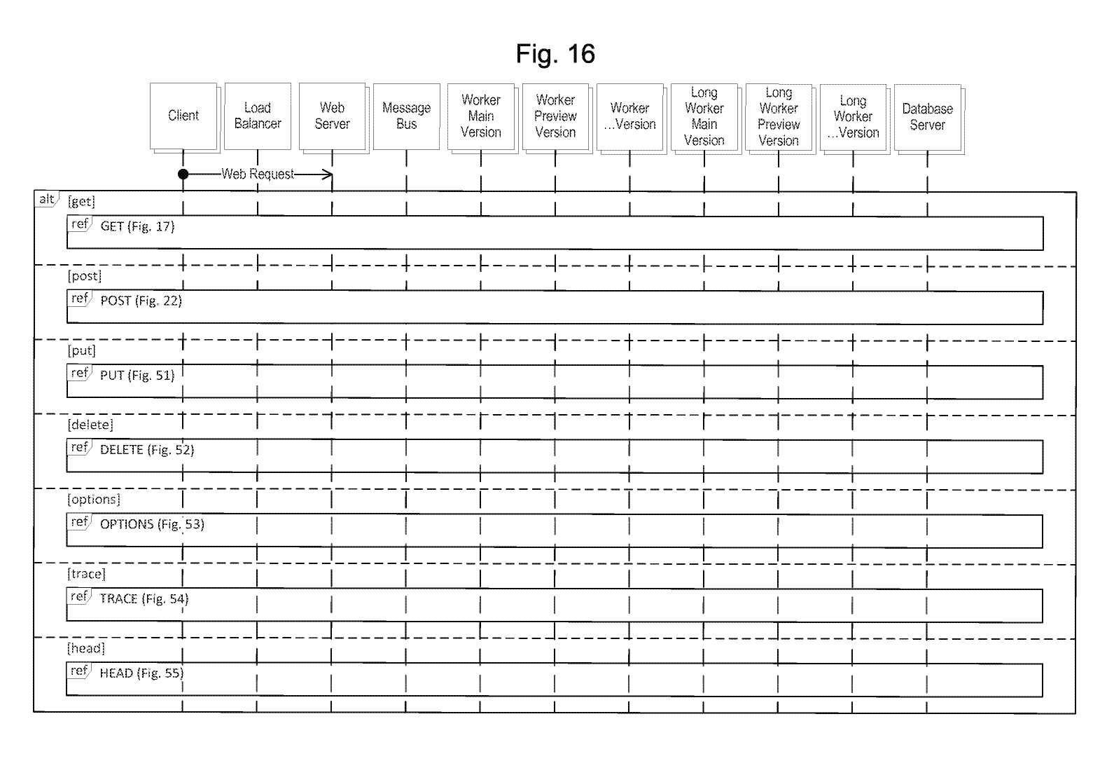

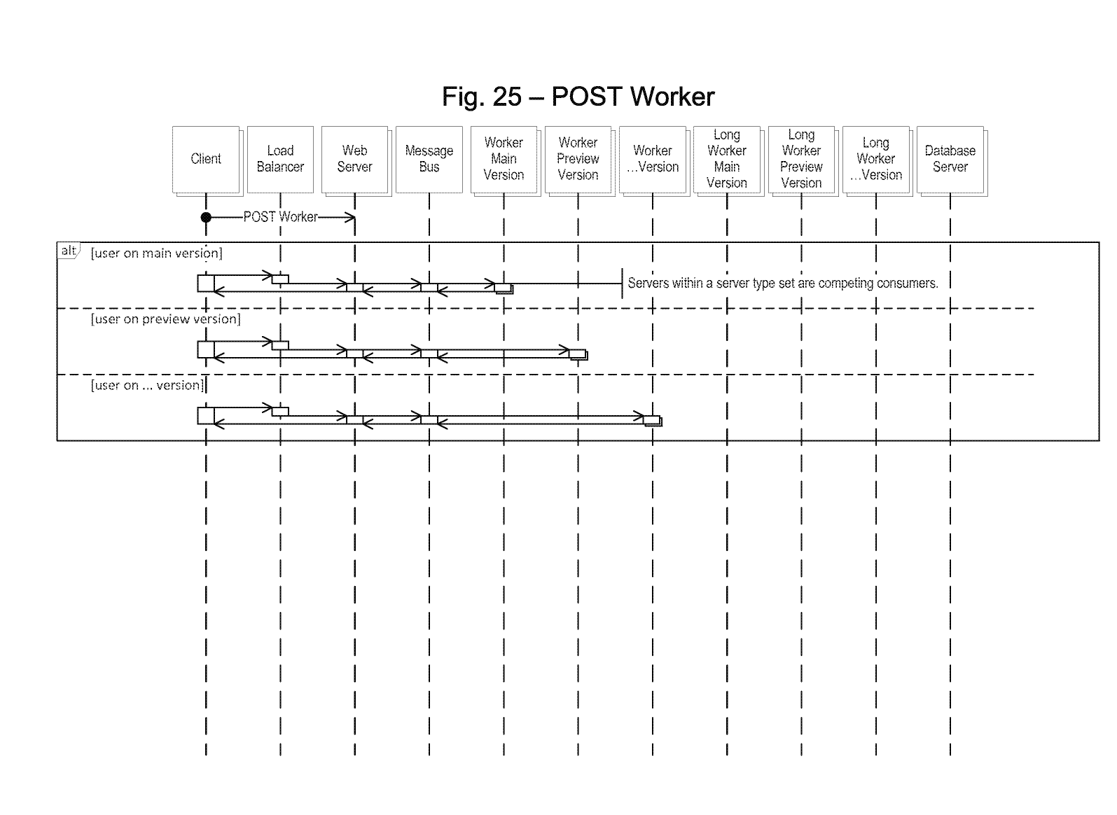

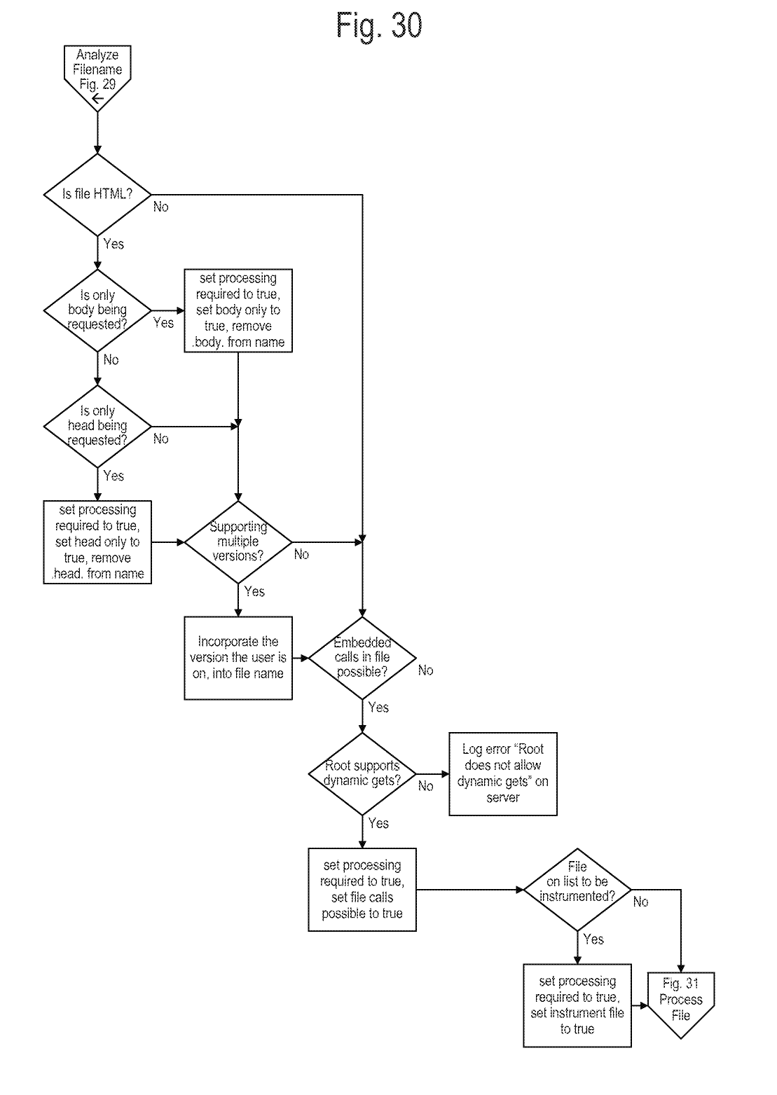

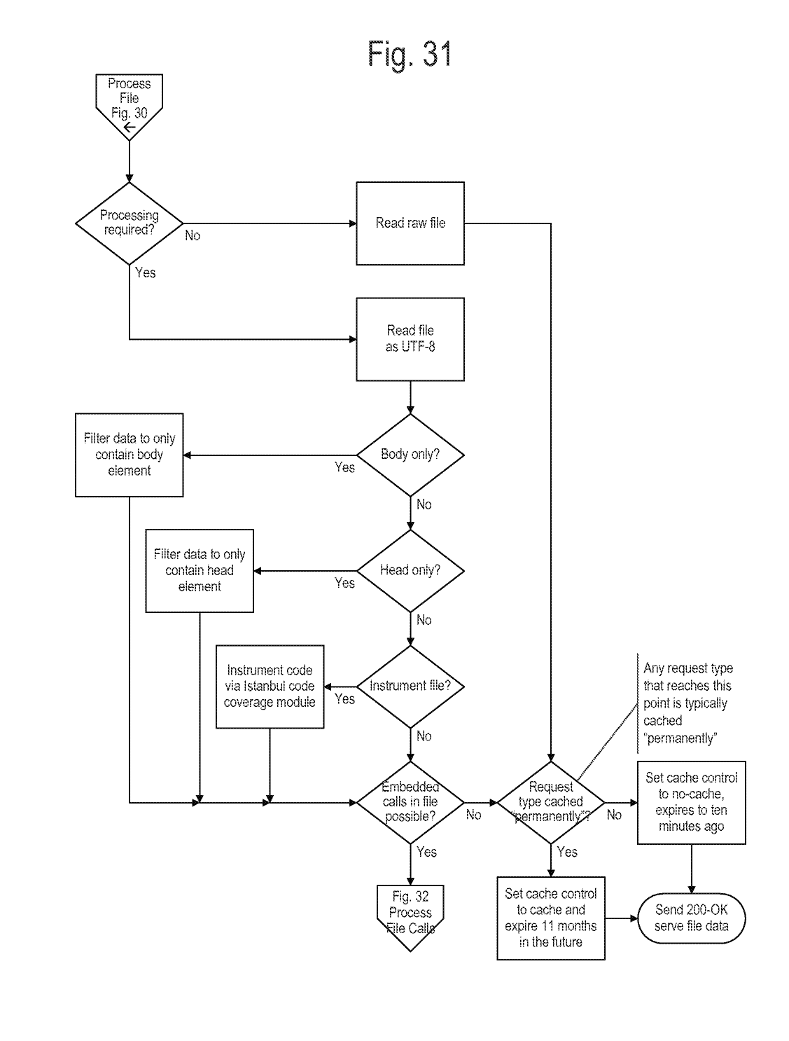

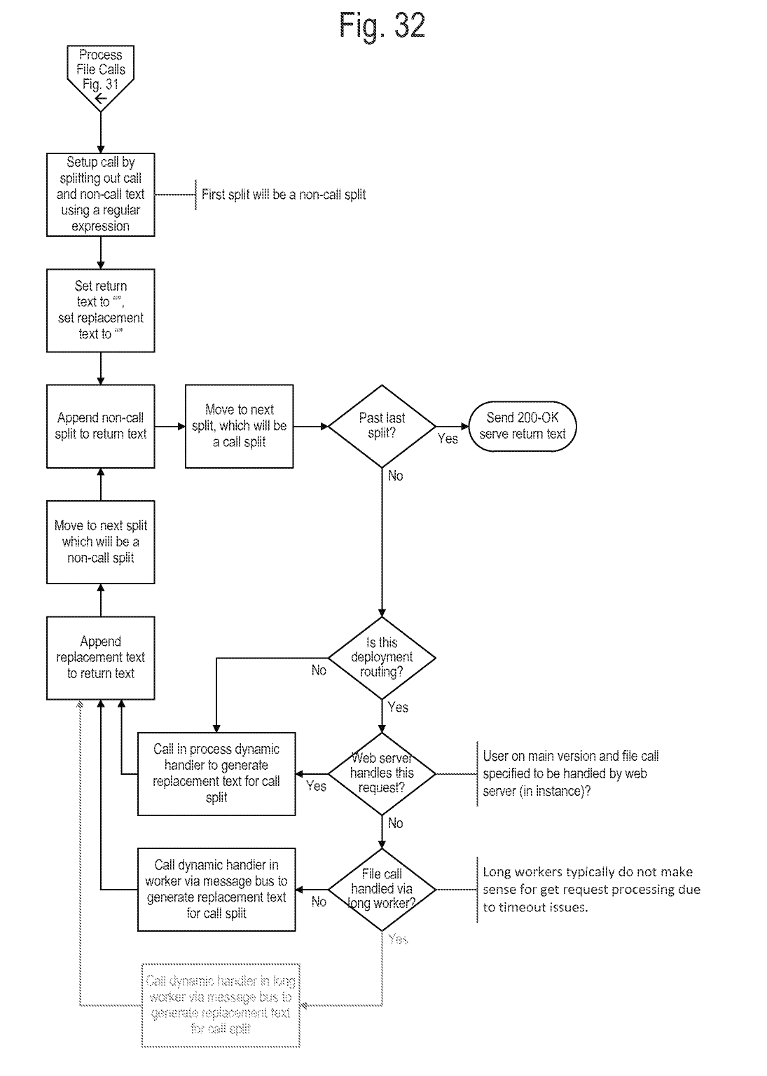

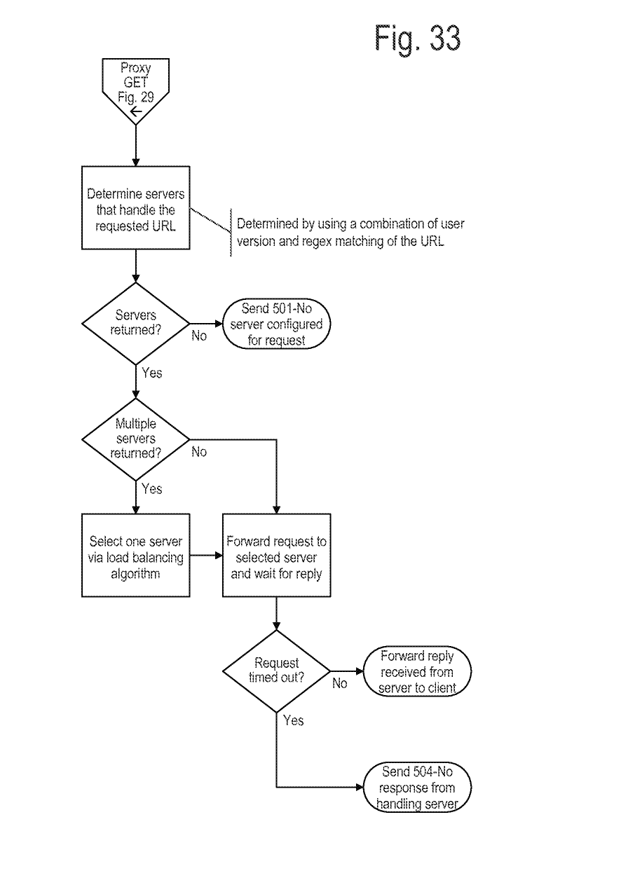

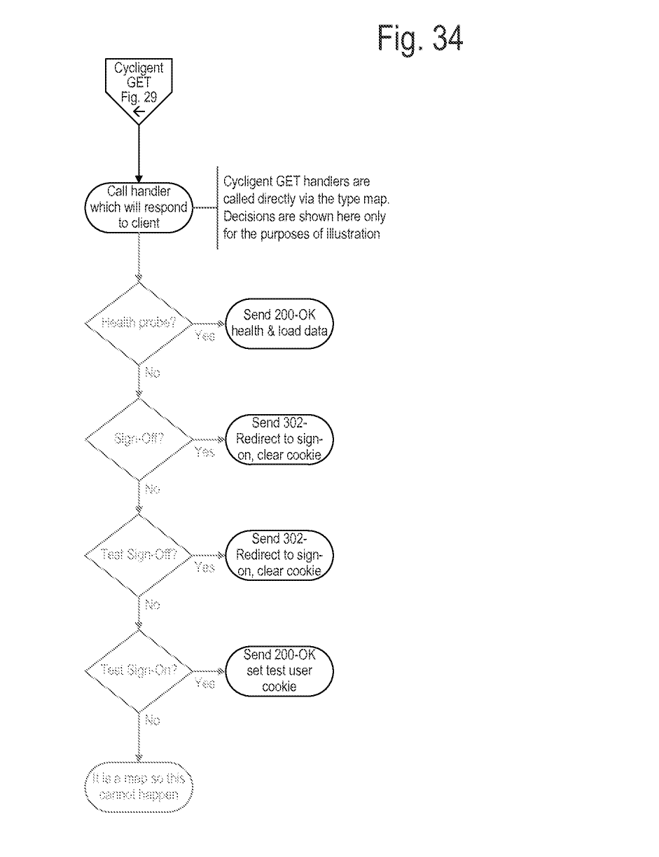

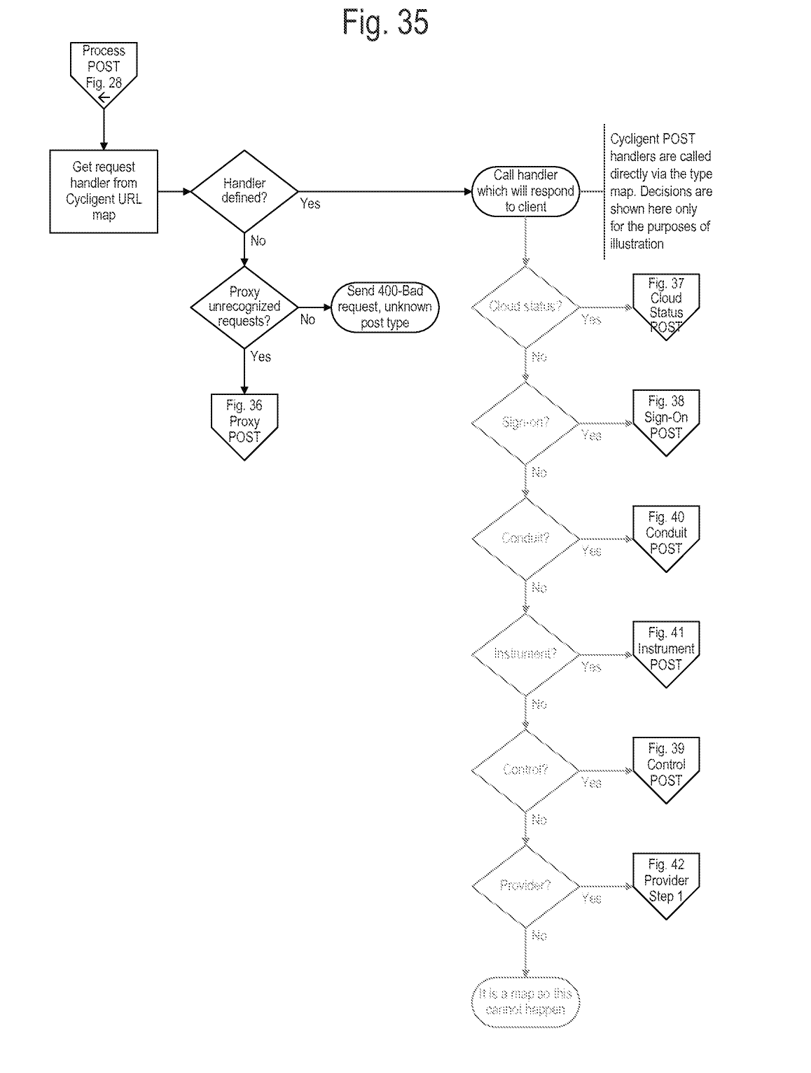

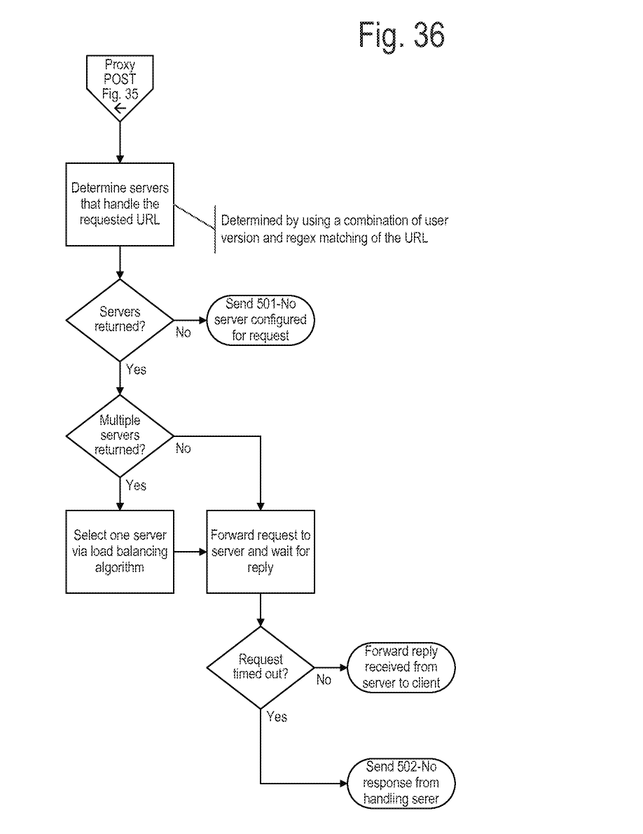

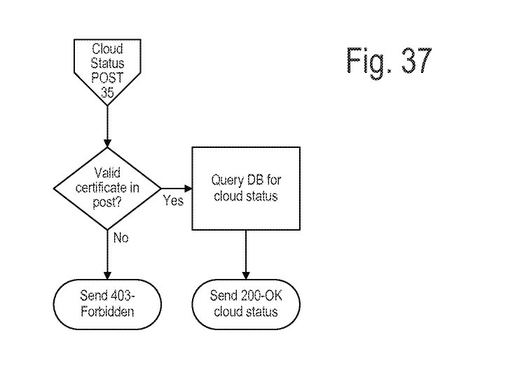

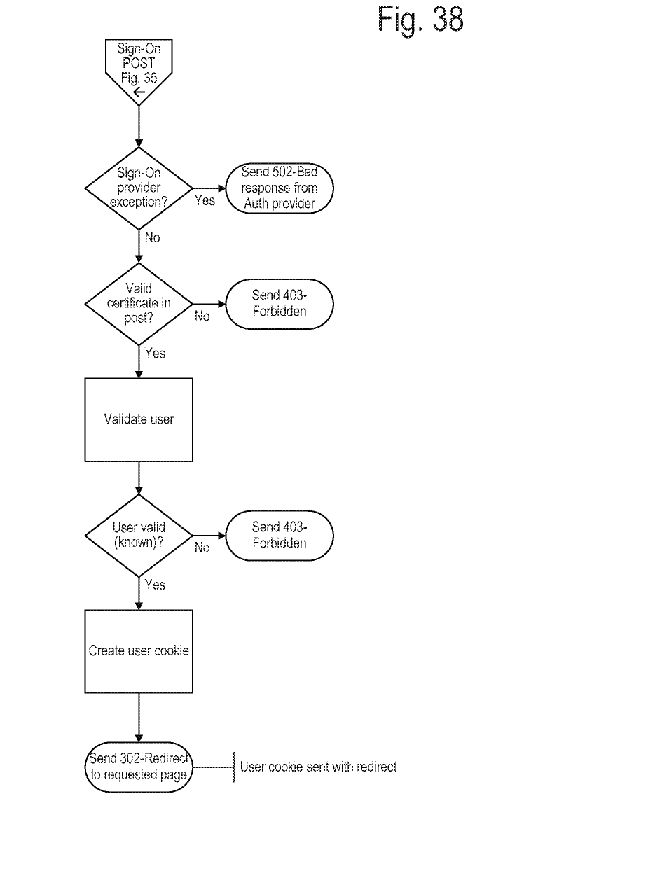

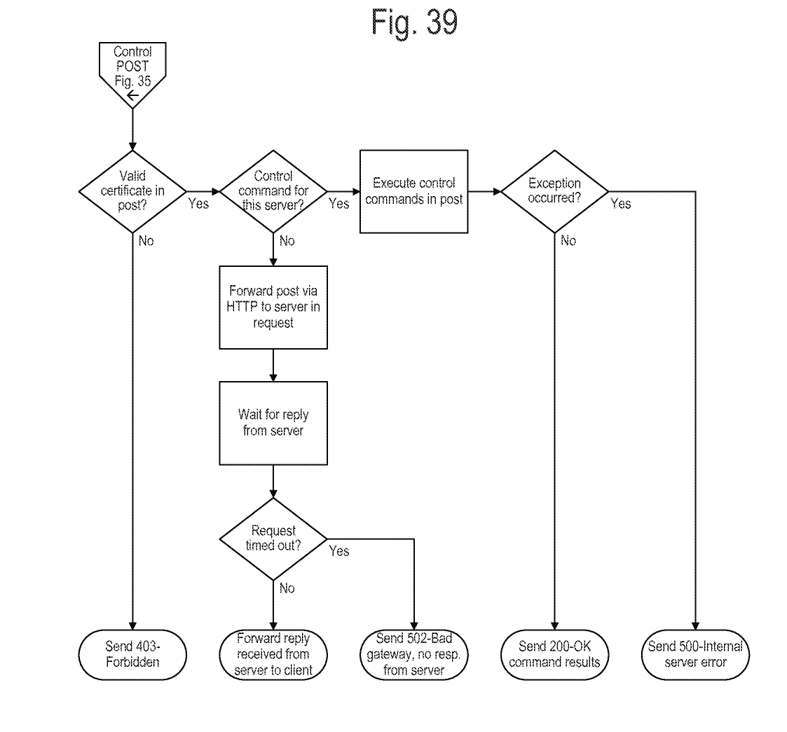

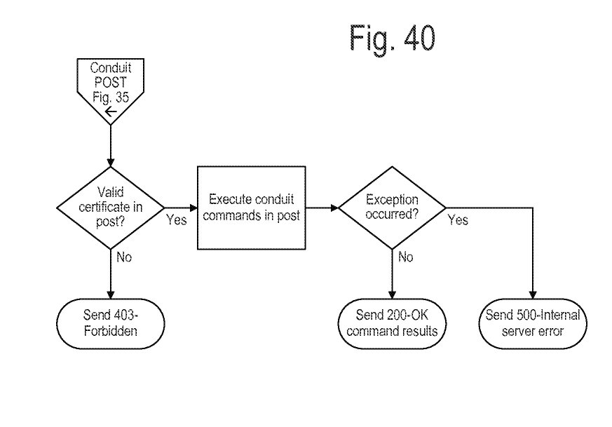

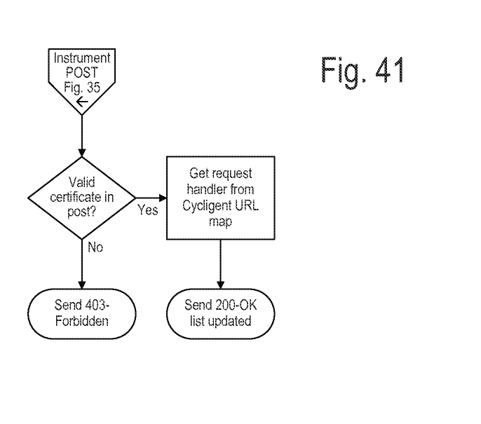

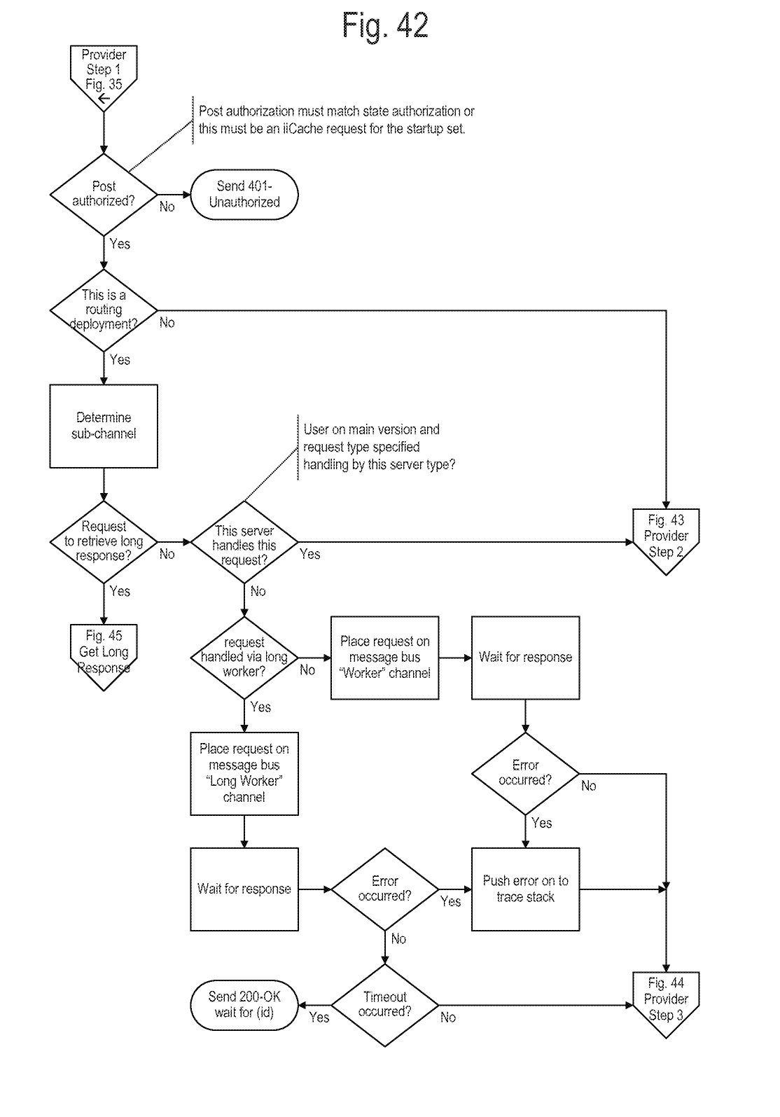

The process of FIG. 1B can comprise processes relating to loading and serving (FIG. 15-50). Once packages have been deployed to a set of one or more holographic servers (i.e., the holographic cloud) the packages' configurations can be loaded and the holographic cloud can become operational and can begin serving content to users.

In an aspect, package loading can comprise one or more holographic servers for loading a configuration file and searching server-side source code for annotations at startup.

In an aspect, holographic environment configuration can be executed via a configuration file or database representation (or other similar configuration construct). The configuration file can describe the applications (roots) that will be served as well as all the environments (server sets, authenticators, database connections, message bus parameters, etc.) in which they may be served. It also defines the types of requests that can be handled by the server or individual applications (roots) and how those requests are handled.

The holographic environment used and the role the holographic server should perform can be passed as command line parameters. In an aspect, if no command line parameters are specified, then the server can start as a single version, single server type instance.

In production environments, operators can make changes to the configuration file to scale and can tune the environment and applications. A user interface (UI) can be provided to update the cloud configuration in real-time. The UI can validate changes to the configuration. Holographic servers can validate the configuration during startup.

Patterns can emerge in configuration files. The configuration loading process can support section references that effectively copy a section of the configuration file for use at another location.

In an aspect, code annotations can be used to conveniently expose server-side functionality to client-side code. A server-side method can be annotated and then can be called directly by client-side-code. At startup a holographic server can scan server-side code for annotations. When the holographic server finds an annotation, the holographic server can set up the appropriate mapping to allow the call to be accessed from a client call.

In an aspect, a general holographic web serving logic used to serve content is provided in FIG. 15. In an aspect, processing can start with the receipt of an HTTP request. In an aspect, the HTTP request can comprise one or more cookies. In a further aspect, the one or more cookies can be analyzed to determine the user. Once the system determines the user, a version of the application to serve can be determined via the user's configuration. In an aspect, the one or more cookies can comprise the version type. Alternatively, the one or more cookies can contain a direct reference to the version type to serve. Next, the requested URL can be analyzed to determine how to handle the request. The holographic cloud configuration can specify how requests are to be handled. Requests can be configured as client-side content, a holographic framework call, a call to server-side functionality or a call to an external server or system. Requests can be configured to be handled either by the web server, a worker, a long worker, or an external server. Lastly, requests for client resources can be configured as being fully static or potentially dynamic (having indications (calls) in the file that are replaced with dynamic content).

In an aspect, there may be no functional difference between a web server and a worker. In an aspect, a web server can provide other functions beyond just the server-side functionality of an application. In an aspect, the web server can process any request that a worker can process but can be configured to handle less, or none, of that functionality so as to conserve the server's bandwidth for non-application functionality.

In an aspect, a request can be checked to determine if the request is handled by an external system. If a request is configured for handling by an external system, then the holographic web server can act as a proxy and can determine which external server is designated to handle the request, and forward the request to the designated external server, optionally applying a load balancing algorithm. The holographic web server can wait for the external server to respond, and can send that response to the requestor. If the request is not handled by an external system then the request can be checked against the configuration to see if the request is for a client resource. If the request is for a client resource, the client resource can be loaded from a holographic deployment package. Holographic deployment packages can contain all the versions of all of the applications being served by a current server. It is determined if the content of the requested resource is dynamically modifiable. If the content is fully static, then the content can be served. Otherwise, if the content is modifiable, the file can be inspected for modifiable content and, if the file contains any modifiable content, that content can be modified appropriately and then served. If the request is not a client resource, the server can determine if the request is handled by the current server. If the request is handled by the current server, then the handler configured for the request can be called and the handler's response can be sent to the requestor.

In an aspect, requests can be subject to internal holographic routing. As an example, if the request is not handled by the current server then the request can be placed on a message bus for handling. In an aspect, the holographic web server can determine on what channel and sub-channel of the message bus the request should be placed. The channel can be, for example, “Worker” or “Long Worker” based on whether the request was designated for processing by a long worker or not. The sub-channel can be set to a request type (Cache, Call, Query, Menu, Download, etc), plus a colon, followed by additional request criteria when appropriate.

The holographic web server can also determine which message bus channel and subchannel a response to the request is expected on. The request is wrapped in a message and placed on the message bus. The server then waits to receive a response until a timeout is issued. Once the message is on the bus, servers of the given type that handle the request can compete for the message. A server retrieving the message first can process the message and can respond via the bus. If the responding server is a “Worker,” then the responding server can respond directly to the web server that made the request. If the response is provided to the web server before the timeout, the web server can then send the response to the requestor. If, on the other hand, the responding server is a “Long Worker,” then the responding server can respond on the “Long Worker Reply” channel.

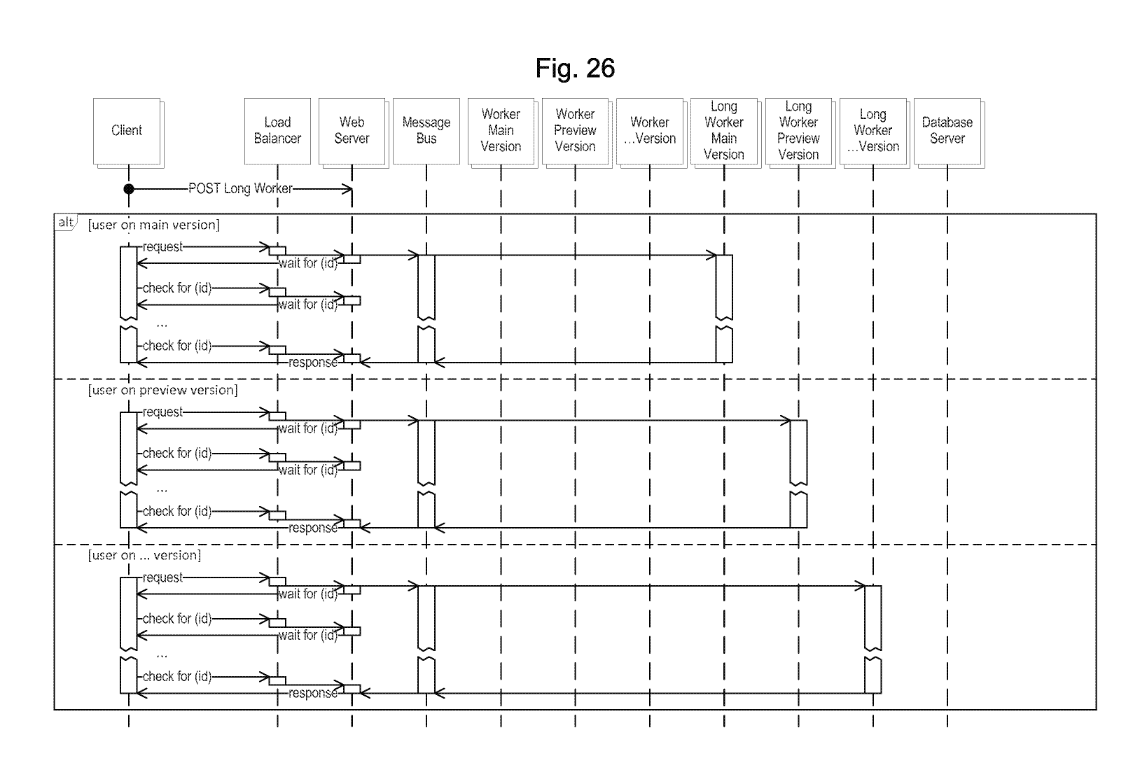

In an aspect, long workers can reply on the special “Long Worker Reply” channel because the web server that initiated the request may not be the one that handles the reply. Long workers can take longer than web timeouts to generate their responses. In an aspect, when a time out is generated, the holographic server determines whether the request is being handled by a long worker. The “Long Worker Reply” channel can allow any web server within the system to pick up a particular response based upon ID and send the response to the original requestor. The long worker reply mechanism can be facilitated by sending the client a wait-for-response (id) message, to which the client can respond with a check-for-response (id) request. Please note that this request may go to a different web server. This process can repeat until the long worker generates a response, at which time that response can be sent back to the client (FIG. 26 and FIG. 45). If the request is not handled by a long worker, the holographic server can send an error to the requestor in response to the timeout.

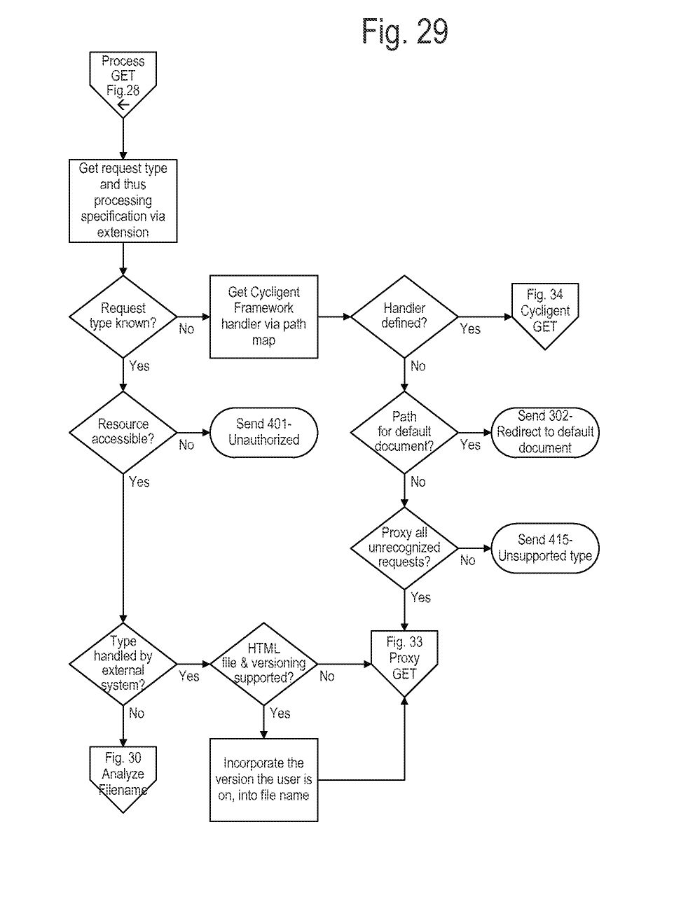

FIGS. 16 and 28 illustrate a holographic web server sequence and logic. The message sequencing diagram (FIG. 16) shows an example of the HTTP requests handled by the holographic server and references the diagrams that show how those requests are handled. The logic overview diagram (FIG. 28) shows an example of the calling of the handler for the HTTP requests, the reading of the post data, and user authentication (or the creation of an anonymous user object).

In an aspect, user authentication can be a key element of the holographic process and can be handled by a holographic web server. User authentication can be key because the user configuration can determine the version of an application that will be served by the holographic system to the user. Changing the version configured for a given user authentication, or more precisely the user's current role, can cause the version that she sees to change.

In another aspect, the version a user sees can be determined by a cookie, a token, a file, a set of data, a user credential, a pseudo-random assignment, or any combination of the foregoing.

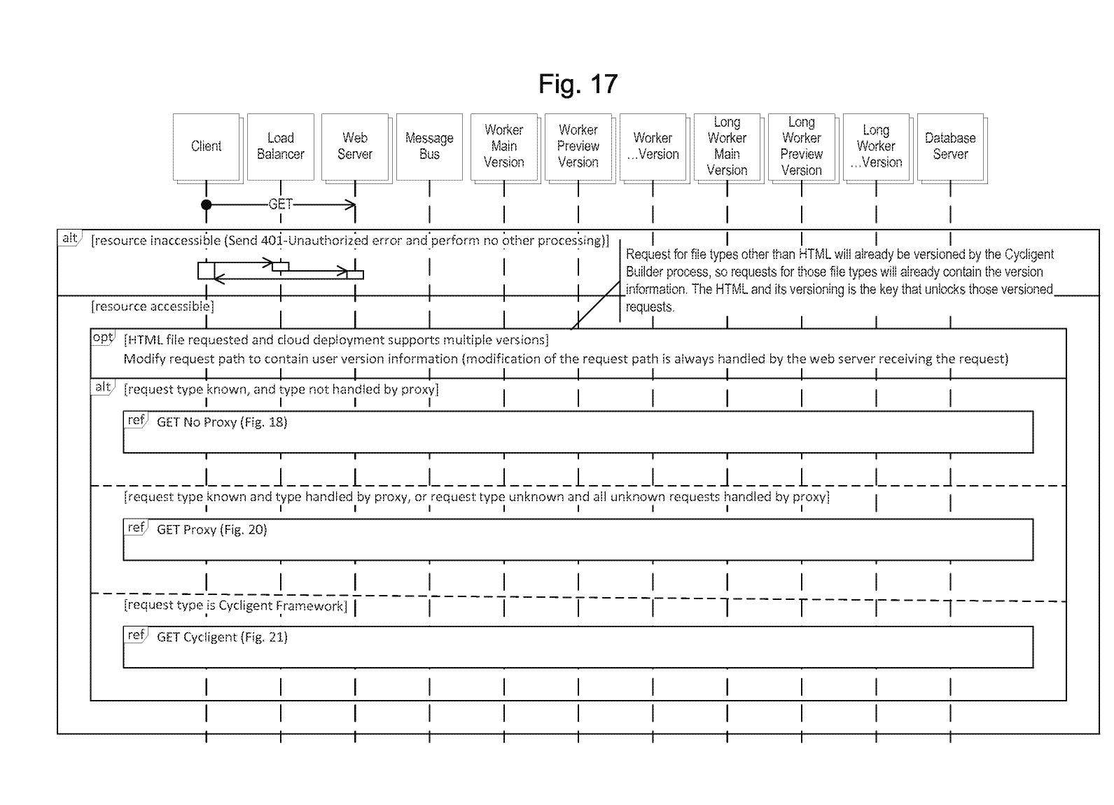

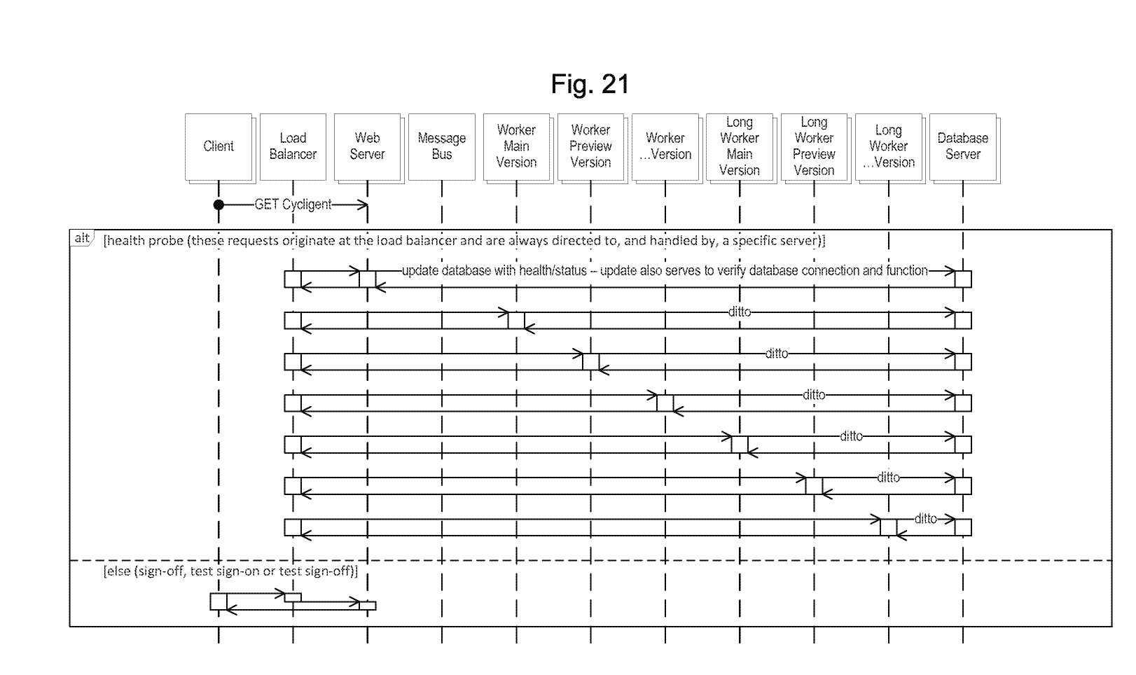

FIGS. 17 and 29 illustrate a sequence and logic of GET processing. GET processing can start by identifying the request type via the file extension in the requesting URL. If present, the extension can yield a type which the server can use to lookup processing specifications in the configuration file. If the extension does not yield a known type, then the URL can be checked against a handler map. If a handler is defined for the URL, then the handler can be called (FIG. 21 (sequence) and FIG. 34 (logic)). If the request type is known, the server can check the configuration of a resource (for instance, check if the configuration is anonymous) and the user authentication to determine if the user is allowed to access the resource. If not, an unauthorized error message can be sent to the client and no further processing of the request takes place; otherwise processing can continue.

In an aspect, if the requested resource is HTML and the deployment supports multiple application versions, then the path of the request can be modified to contain the version number for which the user's current role is configured. Modifications of the request path can be performed by the web server receiving the request. Modification of paths for other resources can be unnecessary. The resources, including HTML resources, can have names that have been modified during the holographic build process to include the version. The build process can update all references to those resources. Any resource which requests other resources can automatically request the correct version of that resource from the web server. The system can handle HTML resources: otherwise, a user can specify a particular version of an HTML resource. Instead, the system can allow a user to request the un-versioned HTML resource and then the holographic system can check the current configuration of the user, and the deployment's configuration of active versions, to deliver the correct HTML resource version. In this way, all versioning functionality can be hidden to users. They can continue to perform all functions, like bookmarking, as with a normal system.

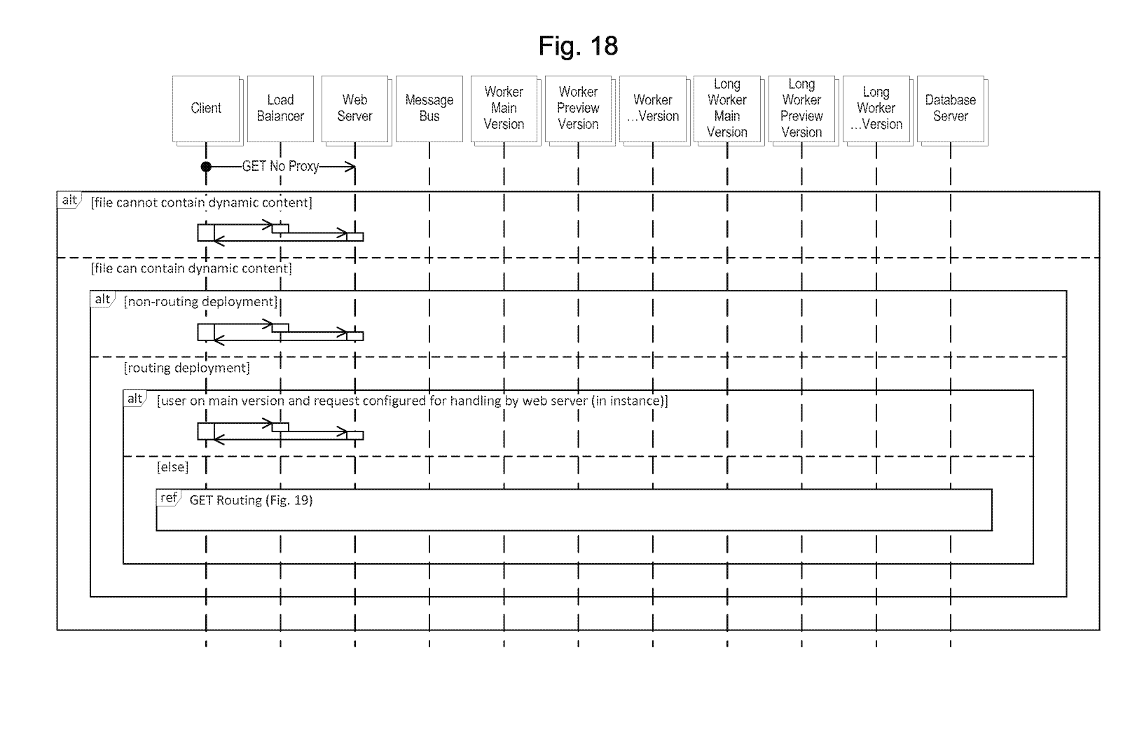

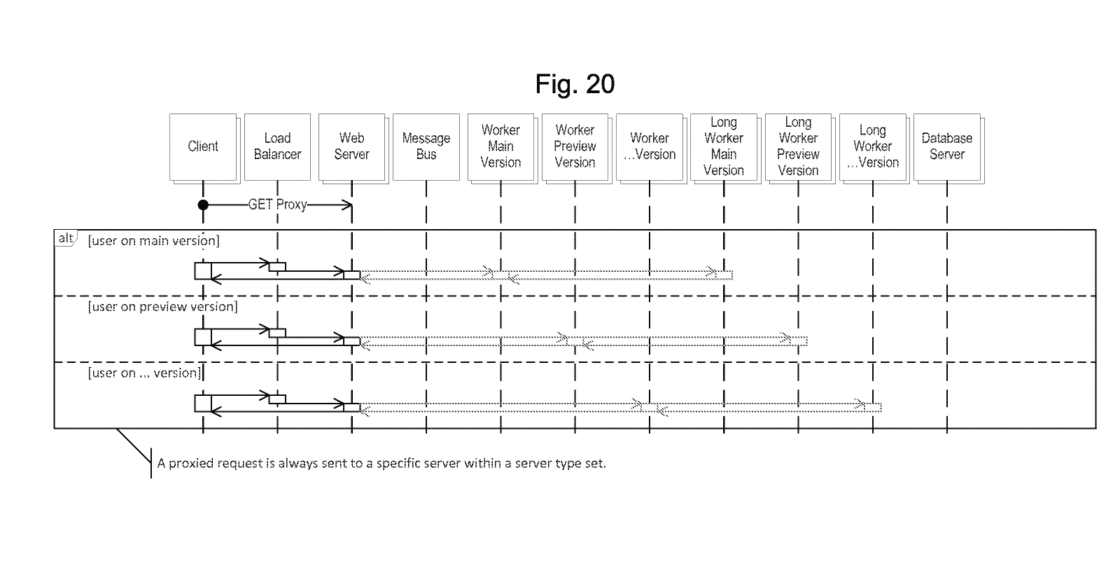

In an aspect, the HTML file can become a key that unlocks access to resources through standard web requests. As an example, resource names can have the version incorporated into the resource names by the holographic build process. The holographic build process can also update all references to the resource names. In an aspect, only the resource names change; the rest of the resource path remains the same. When a request for an HTML file is made of a holographic web server, the web server can add in the version number to the HTML resource name (internally) as described above and return the file to the client. The client can request all other resources referenced by the HTML file, and, when client does request all other resources referenced by the HTML file, the client will be requesting the correct version of the resources because the holographic build process can have already updated the resource names within that HTML file. In an aspect, this can allow for requesting resources without need for any special processing of the request. Requests for the resources can be handled as simple GET requests and the resources requested can be returned as is. The HTML resource can be the key. In an aspect, the correct version of HTML file can be served and all other versioned resources can automatically be asked for by the client directly. This approach also makes it possible for developers to run the system as is (with resources that have not been versioned) on their local computing devices. The HTML resource served on a local computing device may not have a version number as the HTML resource has not been processed by the holographic build process: and, therefore, the HTML resource server on the local computing device can request files that are on the local computing device, without version numbers. In an aspect, the holographic system can determine if the completion of the GET request should be handled by a “GET No Proxy” process (which will be described in more detail in the description for FIG. 18), a “GET Proxy” process (which will be described in more detail in the description for FIG. 20), or a “GET framework” process (which will be described in more detail in the description for FIG. 21).

In an aspect, because the HTML key can cause the client to request versioned files after requesting the initial HTML file, web servers using the holographic process can employ advanced caching techniques. As non-limiting examples, HTML files and dynamic resources can be served as non-cacheable; static resources can be served with a cache expiration of a period beyond an expected life of the version of the static resources. For example, a cache expiration of eleven (11) months in the future can be chosen, effectively caching the files beyond their expected life. In an aspect, the client can send a request for each resource in a local cache to see if a newer version is available on the server, but setting the cache expiration far into the future can cause the client to avoid this check, significantly reducing the number of requests that are handled by the web server and enhancing the responsiveness of the client by removing network latency and transmission time for static content. Non-holographic servers cannot employ this caching strategy because files would get “stranded.” That is, the files would be cached and the application would be unable to replace the files when the application was updated. The HTML file as key overcomes this issue by causing the client to request the appropriate version of the file specifically when versions change.

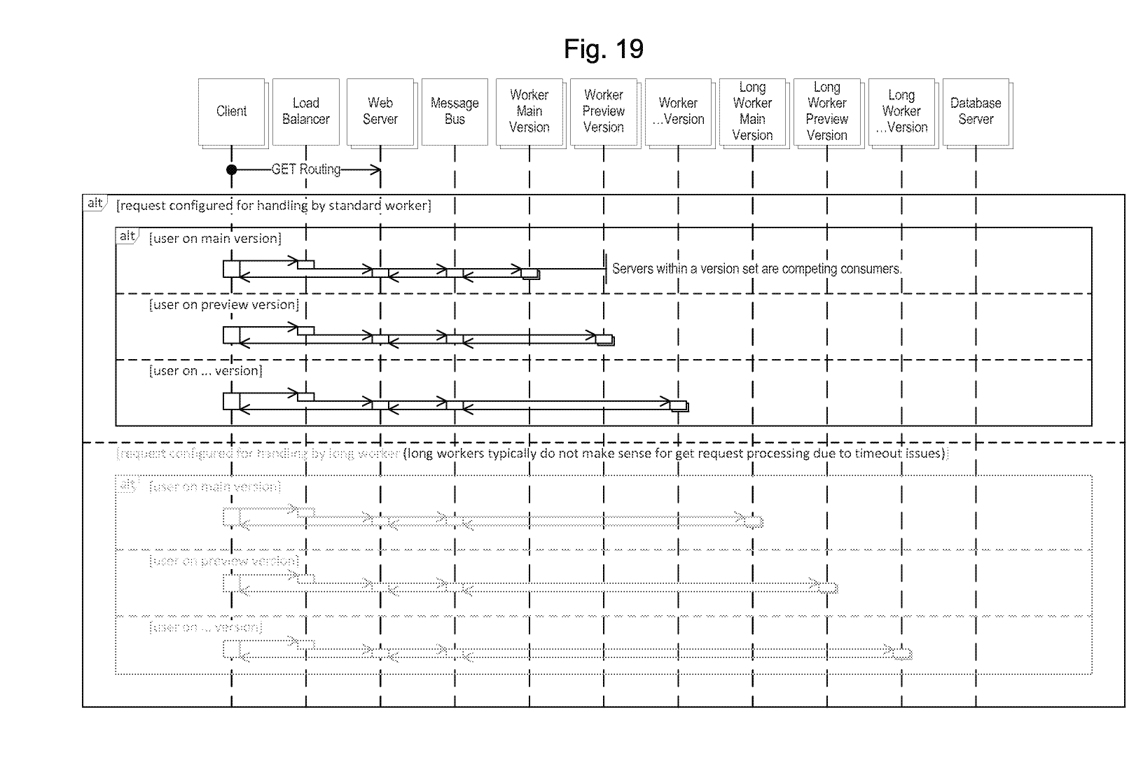

FIGS. 18-19 & 30-32 illustrate a sequence and logic relating to a GET No Proxy process. In an aspect, if the request type is known and the request type is not handled by proxy, then the request can be handled completely by the holographic process. The server uses the “GET No Proxy” process to reply to the request in this instance. GET processing typically handles requests for resources that are static in nature, as in an image or JavaScript file. The requests can, however, also be dynamic in nature. When the requests are static, the web server can handle the request directly. When the requests are dynamic, the web server can marshal the request by loading the requested file and calling other servers to fill in the dynamic content as appropriate. The holographic process can analyze the resource name as described in the configuration files to determine if the content being requested is static or dynamic.

FIGS. 18 & 30 illustrate a sequence and logic relating to a filename analysis. In an aspect, an analysis of the filename can be performed to determine if any processing of the file is required. If the file is an HTML file, the system can check to see if only the head or body portion of the file is being requested (.head or .body appears in the filename directly before the file extension). If so, the head only or body only flags can be set appropriately. This functionality can be used by testing environments. If the current environment supports multiple versions, then the filename of the HTML file can be modified to contain the version number. Next, for all files, the file name can be analyzed to see if the file supports dynamic content calls. If the file does support dynamic content calls, then the request can be flagged for embedded call processing. File types can be configured in the holographic environments configuration file and the file types can be designated as static or dynamic. In an aspect, the resource can be checked to see if the resource is on the instrumentation list. This is a developing and testing function for JavaScript files, whereby, JavaScript files can be instrumented via a code coverage module so that the code that is executed is recorded.

FIG. 31 illustrates logic relating to a file process. In an aspect, once the filename has been analyzed and the appropriate processing flags have been set, the file can be loaded. If the file requires processing then the file can be loaded as Universal Character set-Transformation Format-8 bit (UTF-8) encoded; otherwise, a binary image of the file can be loaded. If the request requires head or body filtering, the contents of the file can be filtered appropriately. If the file needs to be instrumented, the contents of the file can be modified for instrumentation. If the file can contain dynamic content (e.g., if the file can contain embedded calls), then the processing of the file can be turned over to the file calls process. Otherwise, the file's cache header can be set as defined by the request type and the file can be served to the client.

FIG. 19 illustrates logic relating to a process file call. In an aspect, the text of files that contain dynamic content can be split using a regular expression for embedded calls. The splits can start with a non-call split and then can alternate between call splits and non-call splits. At the start of processing, the text to return to the client can be set to an empty string, as can the initial replace text. For each set of alternating splits, replacement text for the call split can be appended to the return text and then the non-call text can be appended. The replacement text can be generated by calling the handler specified in the call split. If this is not a routing deployment or if web servers handle the process request in instance, then the handler is called directly and returns the replacement text for the call. After the splits have been processed the return text can be served to the client.

FIGS. 19 & 32 illustrate a sequence and logic relating to routing a GET call. In an aspect, assuming a routing deployment, if a call is designated to be handled by a worker or long worker, then a web server can wrap the call in a message and place the call on the message bus to be handled by an appropriate server (e.g., server class or server type or server set). The appropriate server can respond via the message bus by retuning the replacement text. After all the splits have been processed the returned replacement text can be served to the client.

In another aspect, servers within a version worker or long worker set can be competing consumers: the first server to receive a message processes the message. Requests can be directed with more granularity than version and worker type (i.e., normal or long). As an example, the request can be directed to a smaller set of competing consumers (servers) via regular expression matching of request type and criteria. In a further aspect, long workers typically do not make sense for GET request processing due to timeout issues.

FIGS. 20 & 33 illustrate a sequence and logic relating to GET Proxy Process. In an aspect, if the request type is known and the type is configured to be handled by an external system, or the request type is unknown and the request is not a framework request and all unknown requests are to be handled by an external system, then the web server can act as a proxy and use the “GET Proxy” process to reply to the request. A proxied request can be sent to a specific server within a server type set. When multiple servers are in the set, a unique server can optionally be selected via a load balancing algorithm. Alternatively, the call can be routed through a hardware load balancer, making the use of the load balancing algorithm unnecessary. Communication of proxied requests can occur via HTTP.

FIGS. 21 & 34 illustrate a sequence and logic relating to a GET framework Process. In an aspect, if a GET request was not a recognized type, but was recognized as a framework request, then a server receiving the request can use the “GET framework” process to reply to the request. The request can be handled directly by the handler associated with the request URL in the framework GET map. All requests (sign-off, test sign-on and test sign-off), other than health probe requests, can be handled directly by the web server receiving the request. Health probes, which typically originate at the load balancer, can be directed to and handled by a specific server. Upon receiving a health probe, a server writes a status related to the server to a database. This also serves to verify database connectivity and function. The server can reply to the probe with an HTTP status code of “200” (OK) meaning the server is healthy; any other response or non-response can indicate the server is not healthy. If the load balancer receives a code other than 200, the load balancer can stop sending requests to the server, other than a health probe, until it again receives a 200 status code from the server. Note that a number of control functions can cause the server to return a status code other than 200, such as, for example, hot deployments and system restarts.

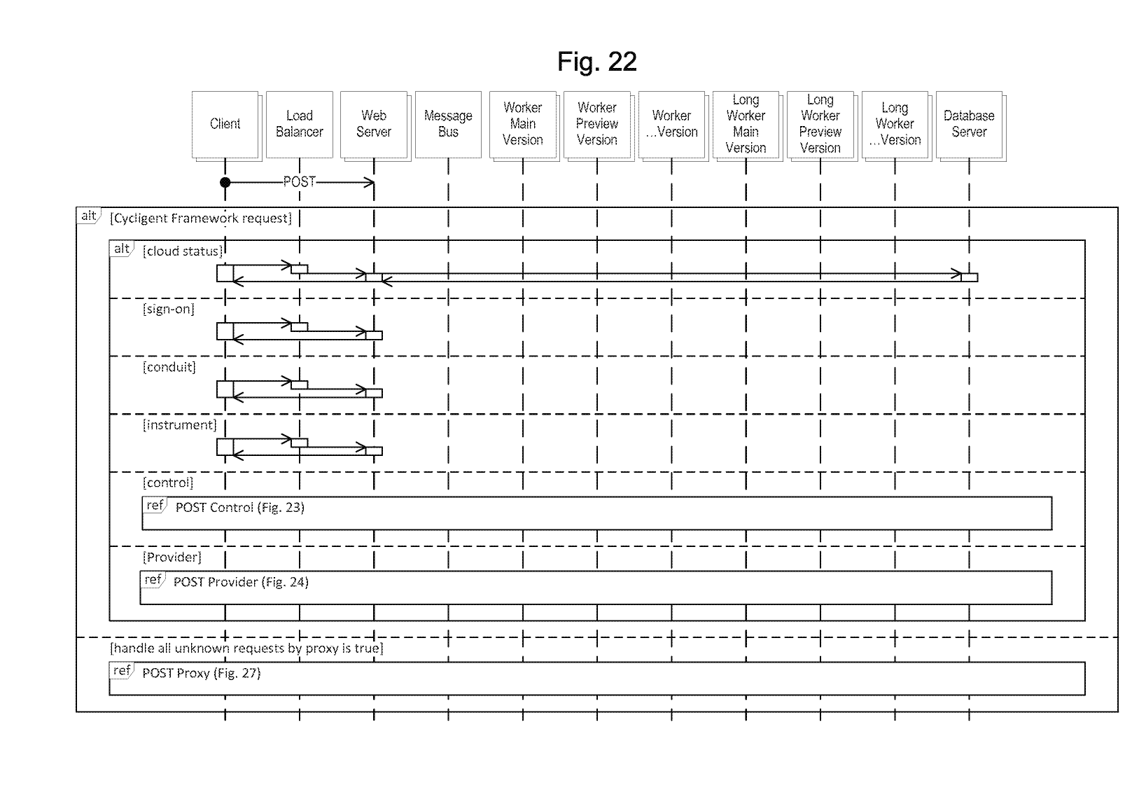

FIGS. 22 & 35 illustrate a sequence and logic relating to POST processing. In an aspect, POST processing can start by identifying framework requests. If the request is a framework request, the server can process the request by calling a framework handler directly via a map. If the request is not a framework request and a setting to proxy unhandled requests is on, then the web server can act as a proxy and forward the request to a server which handles the request. Otherwise, a “400” (Bad Request) error can be returned to the client.

FIGS. 22 & 37 illustrate a sequence and logic relating to a cloud status framework request. In an aspect, any web server receiving the cloud status framework request can query the database for the last status updates placed in the database by the servers in the deployment, or for the last update placed in the database for a particular server specified in the cloud status framework request.

FIGS. 22 & 38 illustrate a sequence and logic relating to a sign-on framework request. In an aspect, framework servers can authenticate users via external authorization providers such as OAuth or Microsoft's Azure Active Directory. Sign-ons can be redirected to the external authorization provider and the external authorization provider can be directed to send a response to a URL specified in the sign-on framework request (e.g., sign-on URL specified in the cloud configuration). If the external authorization provider returns an unexpected response or if the response does not contain a valid certificate, an error can be returned to the client. If the external authorization provider provides a user, that user can be validated. If the user is valid, then an authorization cookie can be created for the user and the user can be redirected to a page that was initially requested. If the user is invalid, for instance if the user is not known to the system or has been marked as inactive, then an error can be returned to the client.

FIGS. 22 & 40 illustrate a sequence and logic relating to an optional conduit framework request. In an aspect, any web server receiving the conduit framework request can validate a certificate in post. If valid, processing can be turned over to a conduit module to update a database accordingly (such as to reset the database to a known state for a particular test). A conduit application can respond to the client as appropriate. If the certificate is missing or invalid, an error can be returned to the client.

FIGS. 22 & 41 illustrate a sequence and logic relating to an instrument framework request. In an aspect, an instrument post can be handled directly by the web server receiving the request. A list of files, such as JavaScript files, that the server should instrument via a code coverage module can be updated. Instrument requests can be applicable in local development and test environments and where only a single server is being used. In another aspect, the instrument framework request can be checked for a valid certificate prior to updating the list. If the certificate is valid, the list can be updated with the data in the POST and a status code of 200 (OK) can be sent to the client. Otherwise, the list is not updated and an error can be returned to the client.

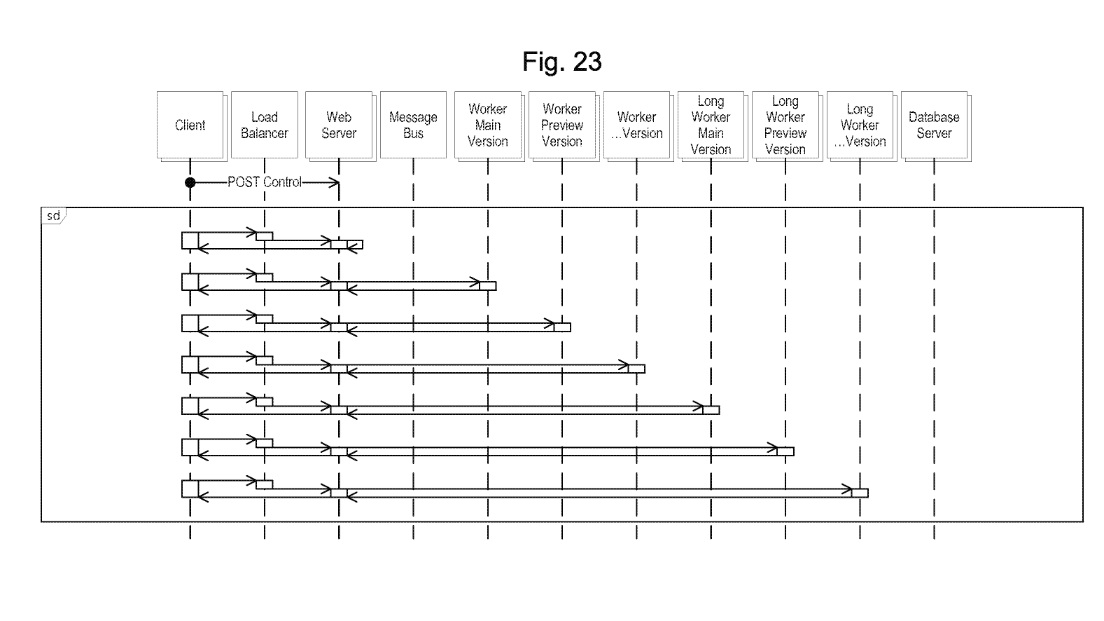

FIGS. 23 & 39 illustrate a sequence and logic relating to a control framework request. In an aspect, control requests can instruct a server to perform a control command, such as pause (stop responding to requests) or restart. Control requests (commands) can be directed to and handled by a specific server. The specific server can be identified and passed as part of the message. Control request processing can begin by checking that a valid certificate was supplied as part of the post. If not, all processing stops and an error can be returned to the client. If the certificate is valid, processing can continue. If the control request was targeted for the server handling the request, then the server can execute the control request in the post immediately. If the request was directed to another server, then the server can act as a proxy, forwarding the control request via HTTP to the server designated in the request, waiting for a reply from the identified server, and sending that reply to the client.

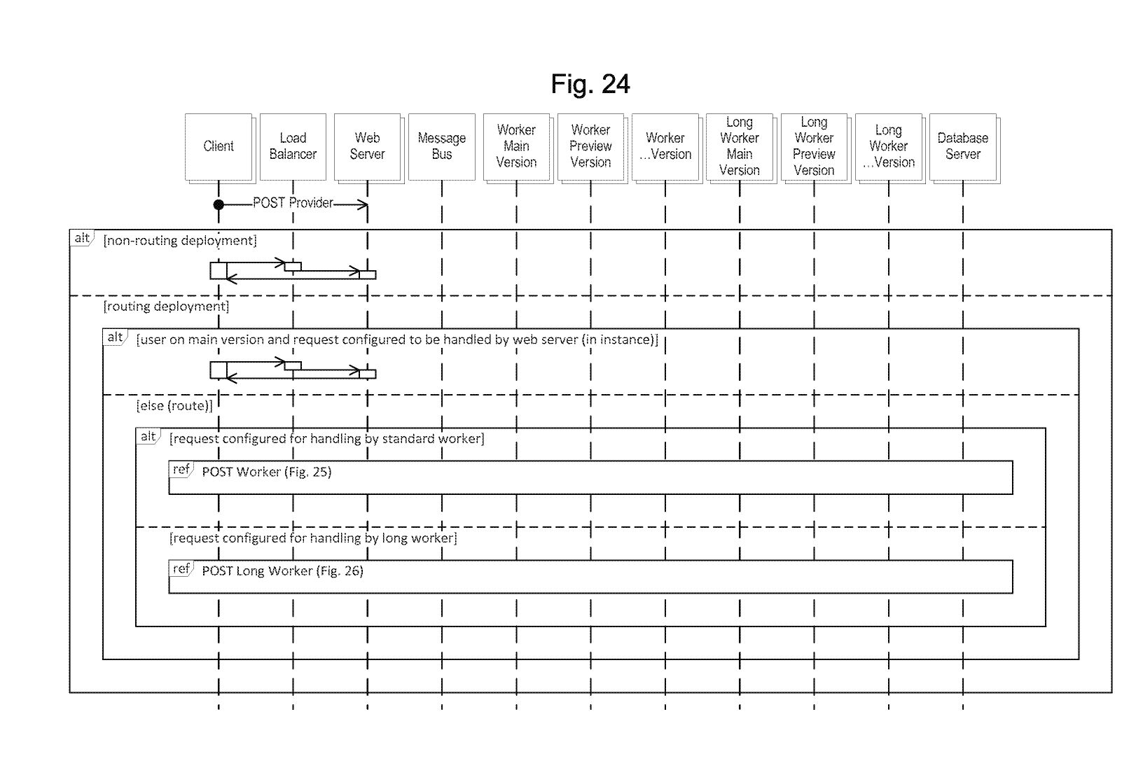

FIGS. 24-26 & 42-45 illustrate a sequence and logic relating to provider framework requests. In an aspect, provider framework requests can be generic post types that invoke code on the server to handle the post. A provider can provide convenient functionality over a raw post, such as scalability. The convenience can be heightened when the client uses the framework. For a provider request, a holographic web server can verify the post's authorization by matching a unique ID, which was originally sent by the server. This can be done to prevent attacks via the provider mechanism. If the server is in a non-routing deployment, the server can proceed to process the request. Non-routing deployments can be used in development and simple test environments. Test environments, including local ones, can also be routing deployments.

For routing deployments, the web server can determine the sub-channel that would be used for communication of the request. The sub-channel can be determined by concatenating the type of request (e.g., Cache, Call, etc) with a colon and the request criteria. If no criteria are used for a particular request type, the colon may not be appended. If the request is to retrieve a long response, then processing can be turned over to the GET long response process. If not, the server can check to see if it handles the request type. If the server does handle the request type, then execution can be turned over to step 2 of the provider process. If the server does not handle the request type, the server can determine if the request is handled by a worker or long worker and place the request on the correct channel of the message bus accordingly. The server can wait for a response on the message bus. If a response is received without error, the response can be forwarded on to step 3 of the provider process. If an error other than a timeout occurs, then the error can be pushed on to the trace stack and logged on the server. Processing can be turned over to step 3 of the provider process, which can create a response from the errors and send that to the client. If a timeout occurs, and the request was to be processed by a standard worker, then an error can be generated. If the request was to be processed by a long worker, however, a message can be sent back to the client telling the client to wait for the response via the long wait process.

In an aspect, servers within a version worker or long worker set can be competing consumers, the first to get the message can process the message. Requests can be directed with more granularity than version and worker type (normal or long) to a smaller set of competing consumers via regular expression matching of request type and criteria.

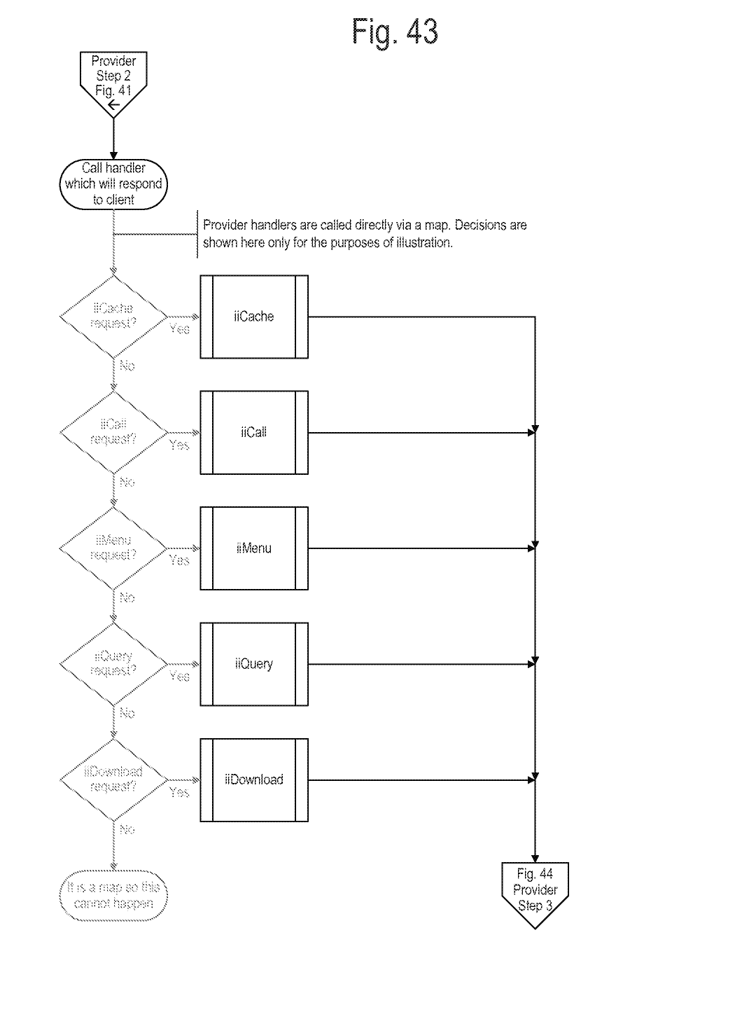

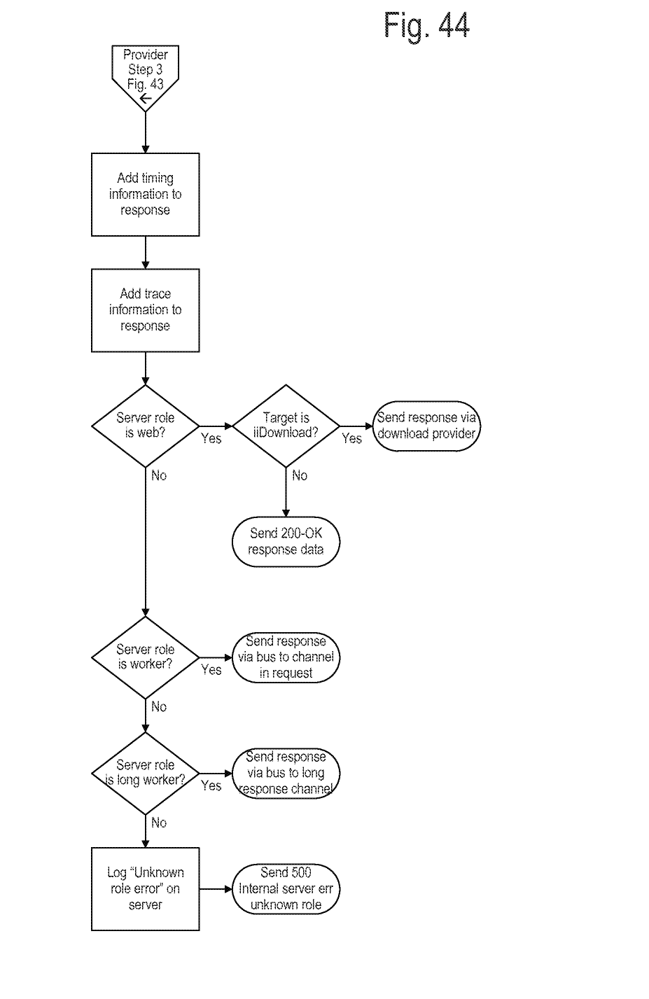

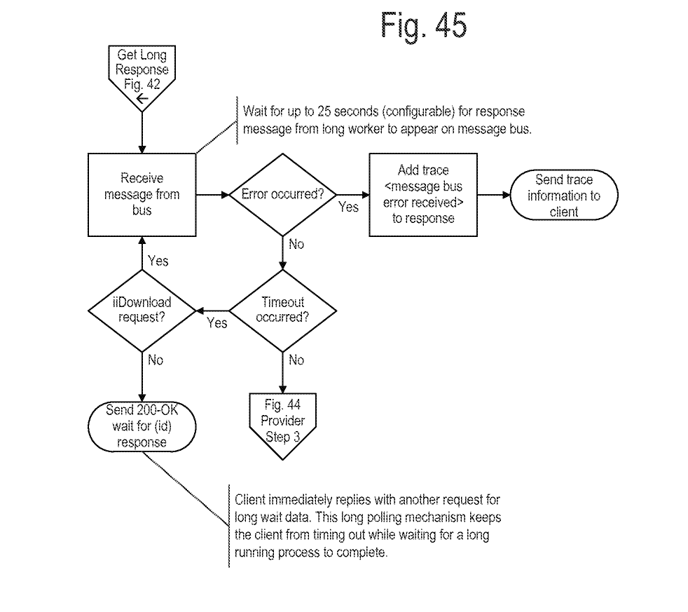

FIG. 43 illustrates logic relating to a provider framework. In an aspect, the provider process can use a map to call a handler associated with a type of provider request being made. FIG. 44 illustrates this call of the provider process. In an aspect, the call of the provider process can take a response generated by a provider handler, whether the provider handler is a local, in-process handler, or a handler on a remote machine, and add timing and trace information to the response to for an enhanced response. If the server is a web server, then the enhanced response can be sent back to the requesting client. Otherwise, the enhanced response can be placed back on the message bus to be picked up by a web server to send to the client. If the server is a worker, then the message can be placed on the message bus channel specific to the web server from which the request originated. If the server is a long worker, then the message can be placed on the message bus channel “Long Worker Reply” from which any web server can retrieve the response when requested to do so by the client. Timing information can report performance metrics, such as processing, network and database processing times, back to the client so the client can be viewed by end users and/or support personnel. Trace information can report errors that occurred on the server in the same manner.

FIGS. 26 & 45 illustrate a sequence and logic relating to a GET long response process. In an aspect, for long workers, the web server receiving the initial request can wait for a period of time (for example, 25 seconds) for the long worker handling the request to respond via the message bus. The selected waiting period can be less than a web request timeout (for example, 30 seconds). If a response is received during the waiting period, the response can be returned to the client. If not, the web server can send out a response telling the client to continue to wait. The client can respond with a check for a response message, effectively disabling HTTP timeouts. The web server receiving the check for response message (each time a new request is received, the new request can be handled by a different web server) can wait for the long worker that is handling the request to respond via the message bus for a period of time (as above). If the long worker responds, then the response can be returned to the client, otherwise, another wait for response message can be issued to the client and the process can repeat until the response is generated by the long worker (or until the long worker times out). Long worker timeouts can be in the tens of minutes. If the request is for Download, then special long processing can be inhibited to allow the file to download normally.

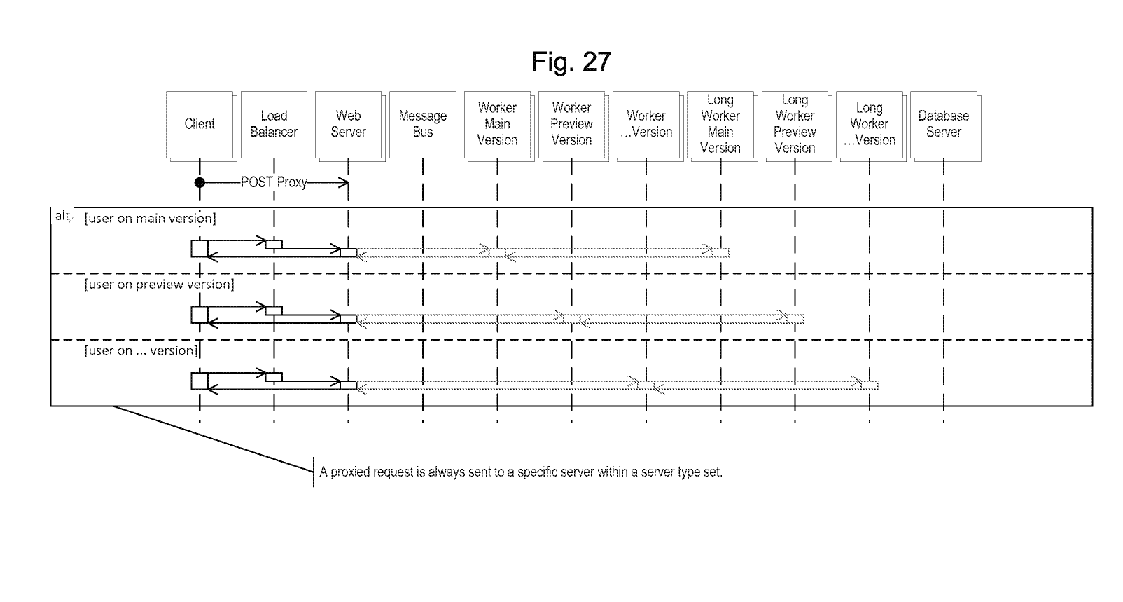

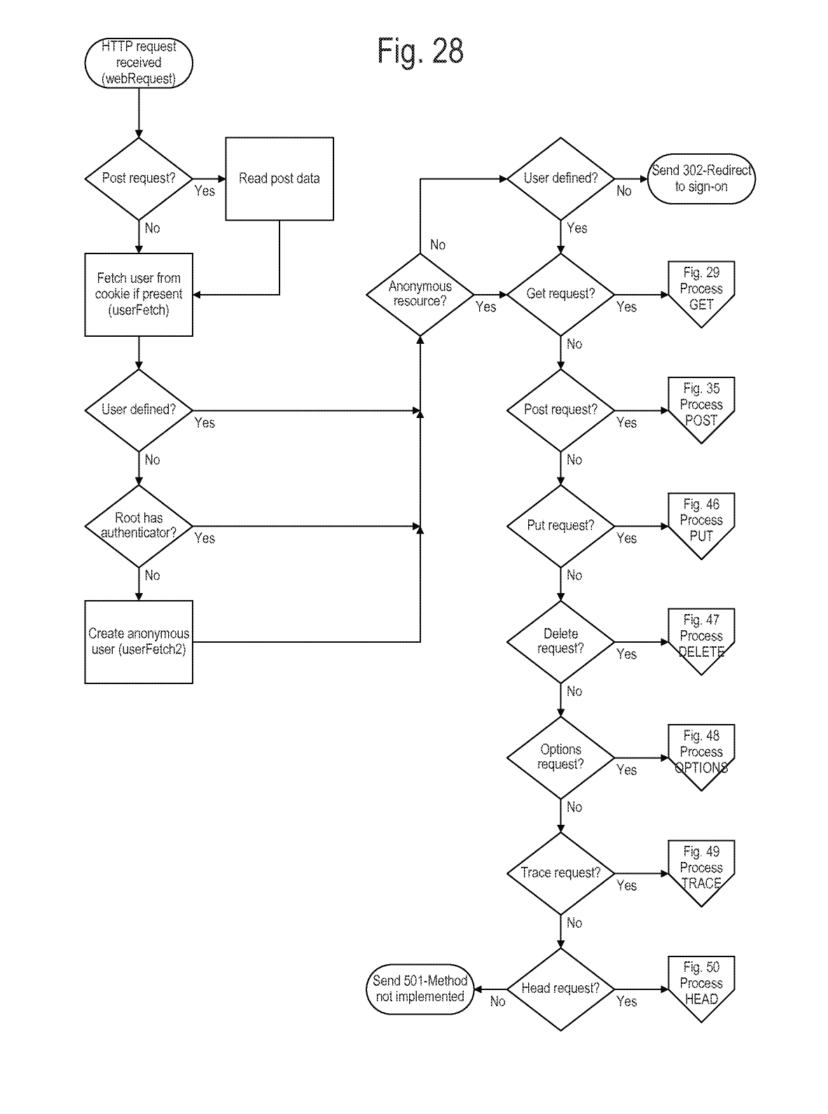

FIGS. 27 & 36 illustrate a sequence and logic relating to a POST proxy. In an aspect, if the request type was not known and “handle all unknown requests via proxy” was on, then the web server can act as a proxy and uses the “POST Proxy” process to reply to the request. A proxied request can be sent to a specific server within a server type set. When multiple servers are in the set, a unique server can be selected via a load balancing algorithm. All communication of proxied requests can occur via Hypertext Transfer Protocol (HTTP). Wait times for proxied requests can remain constant (i.e., not be extended using the framework long wait mechanism). Designation of workers types (i.e., normal and long) is, therefore, unnecessary (as long workers cannot be effectively employed).

As an example implementation, a holographic environment can comprise an automated Amazon Web Services (AWS) EC2 or Windows® Azure construction. Other cloud environments can be used. In an aspect, the methods and system of the present disclosure can provide the ability to construct environments in AWS EC2 or Windows® Azure environments. The constructed environments can support fault tolerance, load balancing, and multiple simultaneous versions. Multiple versions can allow for advanced continuous integration techniques such that you can have a master version and a preview version. In addition to the two production oriented versions, the methods and system of the present disclosure can support simultaneous versions dedicated to testing. As an example, a candidate and daily version can be provided.

In a deployment structure, the methods and system of the present disclosure can use a standard build and deploy directory structure ‘deploys’. This directory structure can be similar to a repository directory structure ‘repos’. Like the ‘repos’ directory, a ‘deploys’ directory can be at a top level of the directory. The ‘repos’ and ‘deploys’ directories can contain platform sub-directories, which in turn can contain company directories, which themselves can contain project directories. The ‘deploys’ directory can mirror ‘repos’ directories. The contents of the project directories, however, can be substantially different. Underneath ‘deploys,’ a project directory can contain a build and deployment configuration file, a number of execution batch files (potentially) for running multiple process tests locally as well as a number of staging and build directories for the currently active versions of the project.

In addition to the ‘deploys’ directories that mirror ‘repos’ directories a ‘deploys’ directory can have a shadow directory structure for each cloud environment to which a project can be deployed. These shadow directories can contain an environment stand-up configuration script. The environment stand-up configuration scripts can set up configuration of the environment and call standard Stand-Up scripts to check the environment, creating any missing elements. As an example, for AWS EC2 or Windows® Azure these scripts can be under the ‘ps’ (PowerShell) platform directory. ‘Company’ and ‘project’ directories can then mirror the ‘repos’ structure. The environment stand-up configuration scripts can be separated from the ‘build’ and ‘deploy’ directories to allow different sharing and security of these powerful scripts which can make large changes to environments. As an example, junior build and deploy staff can be provided with access to the build and deploy directories so that they can deploy new application versions to a cloud environment, while administrators can be provided with access to the scripts that actually modify the configuration and machines of an environment.

In an aspect, a generalized deployment script can reside in the script New-Environment.ps1. There are a number of functions that can be provided by this script. Two more commonly called functions provided by the script are New-DeployEnvironment and New-Environment. New-EnvironmentConfig can be used to establish the base environment configuration. This configuration can then be pipelined into New-Environment along with additional parameters to construct specific environments. New-EnvironmentConfig can create an environment configuration object. This object can then be used to create, check and modify environments via New-Environment. Other parameters can be provided. One such parameter is CompanyMoniker, which can be used to represent a company for which the environment is being constructed. Other parameters can comprise: SubscriptionName, a name of the AWS EC2 or Windows Azure Subscription that will contain the constructed environment; Location, a Windows® Azure data center location; NetAddressPrefix, which can specify the network address space of the virtual network that will contain the environment in CIDR notation; and SubscriptionType, which can indicate the type of subscription. The full active directory domain can be constructed by using the first character of the subscription type followed by a dot followed by the domain postfix. As an example, for a domain having the postfix ‘i3.1o’ and the subscription type ‘Primary’, the active directory domain can be ‘p.i3.1o’. An administrative password, VmAdminPassword, can be used to create virtual machines within the environment. A domain administrator password, DomainAdminPassword can be used to join a newly created virtual machine to the domain. DomainControllerSize can specify the domain controller virtual machine size. DomainControllerImage can specify a name of a virtual machine image to use to create the Active Directory domain controller. MongoVmSize can specify a virtual machine size for a virtual machine associated with a document oriented database, for example a Mongo DB virtual machine size. VmSize can specify a virtual machine size. VmImage can specify a name of a virtual machine image to use to create servers. A WhatIf switch, if present, can cause the deployment script to list all the changes that it would make without actually making any of those changes.

New-Environment can take a pipelined environment configuration object and, based on the additional parameter passed to it, can create, check and/or modify a cloud environment. New-Environment can periodically check for existing elements of an environment, and only create elements of an environment when they do not currently exist. This allows New-Environment to be run multiple times without issue. It can be run just to confirm that an environment is configured properly. An Environment is not an argument for the function, but rather the environment configuration object can be piplined to the function, for example “Senvironment|New-Environment-EnvironmentType Sandbox-WhatIf”, where an EnvironmentType flag specifies a type of environment to be checked/created. The following non-exhaustive list provides some valid example environment types:

| Environment Type | Action Performed |
|---|---|
| Infrastructure | Creates/Checks environment infrastructure. |
| ImageBlanks | Creates images blanks if not already present. |
| ImageBlankMongo | Creates a Mongo DB VM image blank if not |
| | already present. |
| ImageBlank | Creates a VM image blank if not already present. |
| CaptureImages | Captures completed VM images created from |
| | image blanks. |
| CaptureImageMongo | Captures Mongo DB VM image created from |
| | image blank. |
| CaptureImage | Captures VM image create from image blank. |
| Primary | Creates/Checks a primary environment |
| Sandbox | Creates/Checks a sandbox environment |
| Capacity | Creates/Checks a capacity (load testing) |
| | environment. |

In an aspect, the infrastructure can include an affinity group, a virtual network, an infrastructure sub-net of the virtual network, storage accounts, and, if appropriate, an active directory domain controller and a DNS. When a deploy type of ‘ImageBlanks’ is specified New-Environment can check for MongoDB and VM image blanks and, if one or both of the image blanks is not present, the New-Environment can create them. Image blanks can follow the naming convention of ???-i-mdb-image and ???-i-image, where ??? is the company moniker and subscription type. When a deploy type of ‘ImageBlankMongo’ is specified, New-Environment can check for MongoDB image blank and, if not present, can create the image blank. A MongoDB image blank can follow the naming convention of ???-i-mdb-image, where ??? is the company moniker and subscription type. When a deploy type of ‘ImageBlank’ is specified, New-Environment can check for an image blank and, if not present, can create the image blank. The image blank can follow the naming convention of ???-i-image, where ??? is the company moniker and subscription type. In an aspect, when a deploy type of ‘CaptureImages’ is specified, New-Environment can search for one or more image blanks that have been completed and made ready for use (e.g., preparing the system, using, for instance, Microsoft's Sysprep). These images can be in a stopped state. Any such images that New-Environment finds can then be captured and stored as a virtual machine image for use in later environment constructions. When a deploy type of ‘CaptureImageMongo’ is specified, New-Environment can look for a MongoDB VM image blank that has been completed and made ready for use (e.g., preparing the system, using, for instance, Microsoft's Sysprep). The MongoDB VM image can be in a stopped state. Any such image that New-Environment finds can then be captured and stored as a virtual machine image for use in later environment constructions. When a deploy type of ‘CaptureImage’ is specified, New-Environment can look for a VM image blank that have been completed and made ready for use (e.g., preparing the system, using, for instance, Microsoft's Sysprep). The image can be in a stopped state. Any VM image that New-Environment finds can then be captured and stored as a virtual machine image for use in later environment constructions.

In an aspect, Primary, Sandbox & Capacity deploy types can create virtual machines and sub-nets that run deployments. These deployments can comprise multiple base sets or tiers (e.g., database and web) and a number of versions (e.g., master, preview, candidate and daily). Each version can contain a standard worker and a long worker set. The candidate version and the daily version can use a single set that comprises both a non-redundant worker and long worker. VersionType is a character string where each character represents a version to be created/checked. As an example, for a deployment that includes the base sets, master, preview, candidate and daily versions, a space, ‘ ’, can represent the base sets (database and web) of a deployment, ‘m’ can represent the master version sets, ‘p’ can represent the preview version sets, ‘c’ can represent the candidate set and ‘d’ can represent the daily set. To create/check just the base, master and preview sets, the VersionType string is represented as ‘mp’. VersionType is optional. If not specified, New-Environment will create and/or check all versions.

In an aspect, it is possible to simply issue the New-EnvironmentConfig and New-Environment in a pipelined manner on a command line. Alternatively, a script containing standard environment configuration information for a given project is stored in the ‘ps’ shadow directory described above. The configuration specified in the script can then be executed with a simplified parameter structure. This script can be named using the convention of “New-Environment” with a postfix of underline, company moniker and subscription type (i.e., New-Environment_i3p).

As used herein, clients can comprise browsers, but can be any device capable of making HTTP requests. As used herein, Cycligent Cloud is a combination of components comprising Cycligent Builder, Cycligent Agent, and Cycligent Cyvisor. Optionally, Cycligent Server and Cycligent Framework can be used in conjunction with Cycligent Cloud to further aid the coding development process. Cycligent Cloud allows software developers to write code for execution on a single Web server, which facilitates simpler coding, and allows code to run in complex cloud environments utilizing load balancers, web farms, workers, and long workers. Coding can be further simplified by using the Cycligent Framework which provides convenience as well as enhanced functionality within Cycligent Cloud.

Cycligent Cloud does not require the use of Cycligent Framework. Cycligent Framework is a browser based technology that can facilitate client-side development, especially communication with servers, such as a Cycligent Server. Cycligent Framework can provide authentication, authorization, caching of data requests, annotated calls of server-side functionality, seamless processing requests that execute long running processes including timeout suppression, and much more.

In an aspect, Cycligent Builder can implement caching and/or versioning. One of the goals of the Cycligent Framework is to facilitate the fast loading of resources. Two vehicles used to accomplish this are caching and versioning. In an aspect, the Cycligent Framework can employ an advanced caching scheme that enables caching of files in a client's browser cache and helps to reduce or eliminate the need for the browser to check with the server regarding the age of the file and if it needs to be refreshed in the cache. This caching scheme reduces HTTP traffic, and thus reduces the time to load a page. The advanced caching scheme can facilitate “holographic” deployments such as the ability for multiple versions of an application to reside in the same place on the same servers. A byproduct of the advanced caching scheme is that once a file is cached by the client's browser there is no easy way to change it. This has the potential to make future deployments of the application very difficult. The Framework addresses this issue via versioning.

In an aspect, the Cycligent Framework can implement versioning. As an example, an application version number can define the version number for certain files that are delivered to the client. The files having a version number tied to the application version number can include JavaScript, CSS and Image files. HTML files typically have file names that are not dependent on the application version number so that bookmarks remain effective when changing to a new application version. The application version number can be controlled and automatically updated by the build system. In addition to displaying the information the Framework can also compare the application wide version information to data returned from the server when a session is established, and can issue a warning if the version numbers do not match. The application versioning can help to solve the cache refreshing issue: Loading an application page can begin with loading an HTML (markup) file. The server can serve the HTML file with caching disabled so the file is loaded from the server. The Cycligent Framework can enable the HTML file to be of a relatively minimal size, containing startup and layout information. The rest of the page can be built on the fly by the application.

Because the HTML file is not cached, any later deployments that change the markup file can be loaded by the client. Thus, the HTML file can be used to get other versions of files to load. This can be done by changing the version of the loader that gets loaded, which in turn will load a different configuration file during startup. The configuration file then can define version information for all other files in the system, effectively allowing those files to be changed at will. The changing and maintenance of file versions can be handled automatically by Cycligent Builder.

To provide an additional optimization the Cycligent system, a cache expiration time can be set so that cached HTML files expire some period (e.g., four hours) from being served, rather than not being cached at all. This additional optimization can be used in situations where deployments occur during no-use periods. The cache expiration time can then be set to a shorter time period than the no-use period. In this way, when a user comes back into the system after the no-use period, the user will receive the latest version of the system (i.e., the newest version of the HTML files), but the system can cache HTML files during typical usage.

Image files (.png, .gif, .jpg, .jpeg), sound files (.mp3), style sheet (.css) and JavaScript (.js) files can be served by the server, with a relatively long cache expiration time (e.g., on the order of 11 months), effectively eliminating the need for the client to ever check with the server again to see if the file has been updated. These files can have version numbers appended to their file name (e.g. a version number added to the file name just before the extension). This can allow a different file to be downloaded at a different time when the version number of the system changes. The Cycligent build process can automatically update file names and references to those files.

When run by a developer or in a development test environment (i.e., when config.production=false) version numbers or other postfixes can be omitted. The system can run with the files and references directly as they were defined by the developers and stored in the source code control system. The application server can serve all files in this configuration with relatively short cache expiration times (i.e., to expire immediately), effectively disabling caching.

When a build is processed for deployment to an environment beyond development, such as quality assurance or production (config.production=true), Cycligent Builder can automatically add a postfix of the version number to file names and references to those files. If the file is also minimized, which can apply to, for example, .css and .js files, then a further postfix of “.min” can be applied to thee file names and references to the minimized files. These postfixes can be applied at or near the end of the file name (e.g., just prior to the file extension).

When an application server serves files in this configuration js, .css, .png, .gif, .jpg, .jpeg and .mp3 files can be served to with a relatively long cache expiration time (e.g., 11 months), effectively telling the client that these files will not change. The browser then can cache these files and can stop checking with the server to see if the file has been updated, based on the cache expiration time.

The server can decide how to set caching information in the header of a given file by checking to see if the file has a version number triplet of the form “major.minor.build” preceded by a dash (-) and followed by the file extension. If so, the server can enable long-term caching of the file, otherwise the serer can disable caching of the file. As an example, a regular expression of “−\\d+\\.\\d+\\.\\d+\\<file extension>” matches any file that should be cached, where <file extension> is replaced with the extension of the file being served.

In an aspect, the Cycligent Framework can be based on asynchronous messaging operations. Standard web resources, such as style sheets, JavaScript and image files can be loaded via asynchronous, dependency optimized methods. These messaging operations can include a message version and an application version.

Inducing the application version can allow Cycligent Server to appropriately route and process messages for a particular application version. This enables “holographic” deployments where multiple versions of an application can be run in the same environments with different versions being used by different users (i.e. side-by-side versions).

In an aspect, a Cycligent Server can process and respond to application-specific messages. Because of the holographic nature of Cycligent Cloud deployments, any server can serve any function at any time. What function a server is currently performing is configurable and can even be changed on the fly.

Cycligent Servers performing a web server role can serve application specific static resources for all versions currently active in the environment. Web servers can also serve dynamic content for the main version (e.g., the primary production version). Requests for dynamic content for other versions can be routed via the Cycligent Message Bus to servers that handle dynamic content for the particular version requested.

These servers can place the response back on the Cycligent Message Bus, which routes the response messages back through the web servers to the client that originated the request. Cycligent Cloud can take care of all necessary routing, even for long running and load balanced requests, to ensure that the client gets the appropriate response.

All of the Cycligent functionality can be transparent to the application code. That is, the code does not require any particular changes. Cycligent Cloud handles all Cycligent functionality and the actual configuration of any environment is fully configurable (from a single developer's machine to a massive production deployment consisting of hundreds or even thousands of machines).

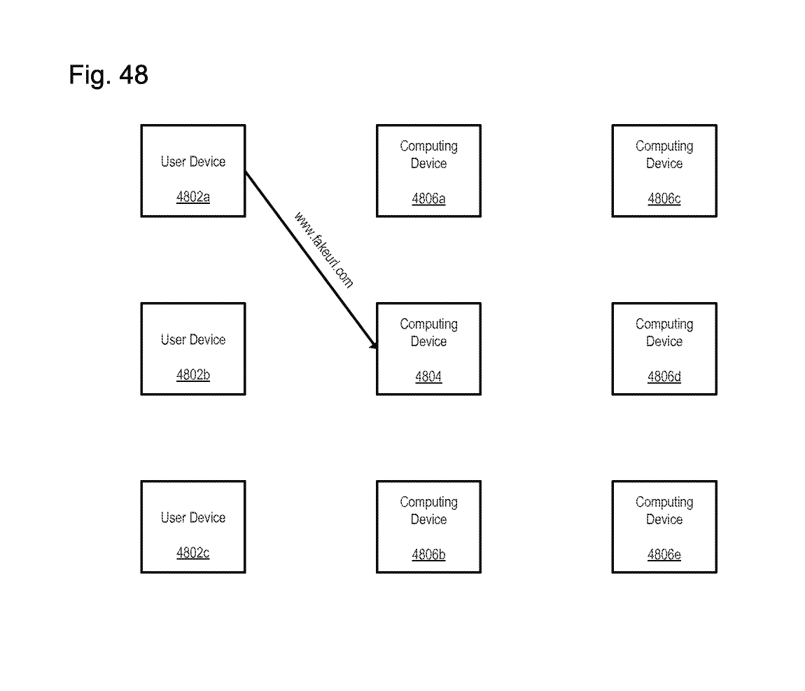

Turning now to FIG. 48, a block diagram is displayed. In an aspect, one or more user devices 4802a, 4802b, 4802c can communicate through a network with one or more computing devices 4804, 4806a, 4806b, 4806c, 4806d, 4806e. In an aspect, a request for a resource from the one or more user devices 4802a, 4802b, 4802c can be routed to one or more first computing devices. In an aspect, the requested resource can comprise a plurality of associated of versions. For example, a user device 4802a can request a URL address, for instance, www.fakeurl.com. In the example, the request can be routed to the first computing device 4804. The first computing device 4804 can optionally include a load balancer. Requests sent to the first computing device 4804 can be routed to one or more second computing devices 4806a, 4806b, 4806c, 4806d, 4806e through a network.

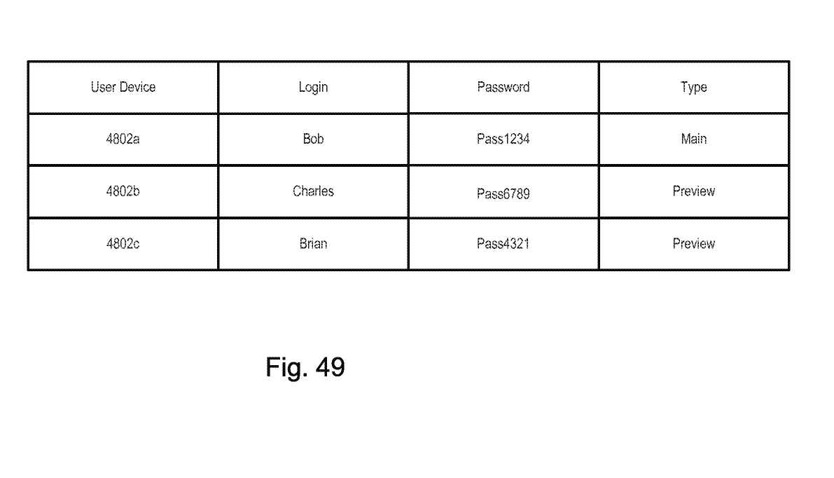

Turning now to FIG. 49, a database table is displayed. In an aspect, the first computing device 4804 can access one or more databases locally or remotely. In an aspect, the one or more databases can comprise the database table in FIG. 49. In an aspect, the database table can comprise a column for user devices. In an aspect, an identifier for a user device can be used. For example, a media access control address (MAC address) can be used to identify a user device. In an aspect, the database table can comprise one or more columns for user authentication. In a further aspect, the database table can comprise a column for login. In an aspect, a key for the database column can comprise one or more of the column for user devices and/or the column for login. In a further aspect, the database table can comprise a column for password. In an aspect, the database table can comprise a column for type. For example, a type can be used to associate a user and/or a user device to a version of the requested resource. In an aspect, fields on the same row can be associated together. In an aspect, the database table of FIG. 49 can be unnecessary if the type is determined by one or more of the following: a cookie, a token, a file, a set of data, and/or a pseudo-random assignment.

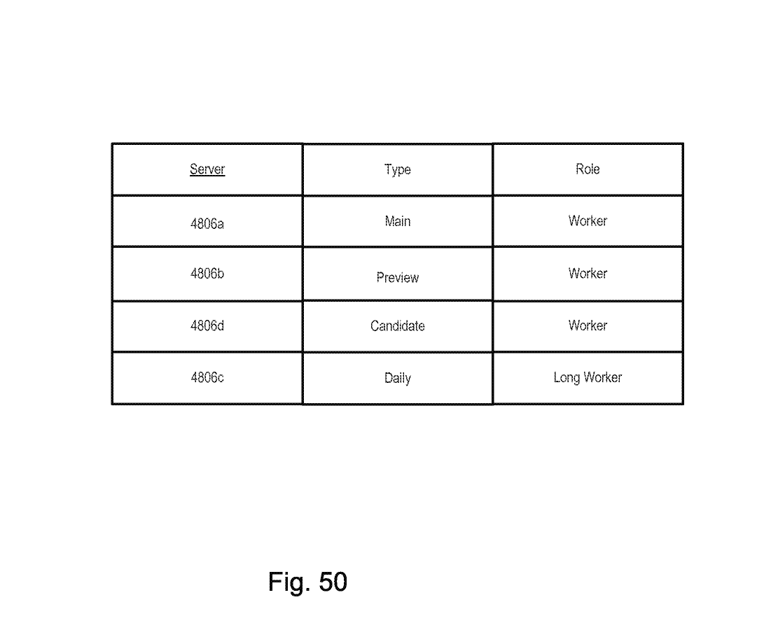

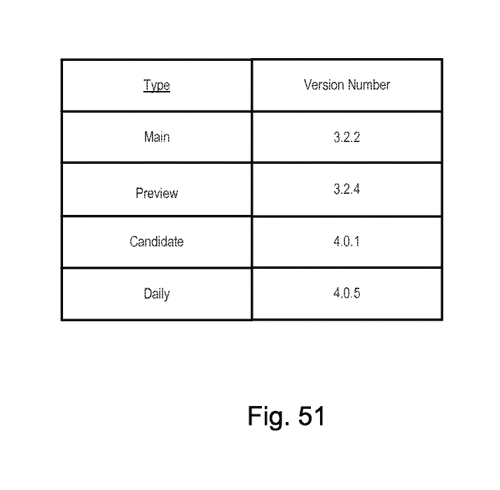

Turning now to FIG. 50, a database table is displayed. In an aspect, the one or more databases can comprise the database table in FIG. 50. In an aspect, the database table can comprise a column for a server. In an aspect, a key for the database table can comprise the column for the server. In an aspect, the database table can comprise a column for type. For example, a type can be used to associate a user and/or a user device to a version number of the requested resource, as will be explained further in FIG. 51. In an aspect, servers can comprise roles. In an aspect, a role can be one of a web server, a worker, and a long worker. In an aspect, long workers can be servers that are dedicated to processes that are known to exceed a predetermined time. In an aspect, a web server and/or a worker can be servers that are not dedicated to processes that are known to exceed a predetermined time. For example, the predetermined time can be 30 seconds and a determination can be made that a particular request signature takes 35 seconds. Therefore, a server in the role of “long worker” can be used to process the particular request signature. In an aspect, the database table can comprise a column for the role of the server. In an aspect, fields on the same row can be associated together.

Turning now to FIG. 51, a database table is displayed. In an aspect, the one or more databases can comprise the database table in FIG. 51. In an aspect, the database table can comprise a column for a type. In an aspect, a key for the database table can comprise the column for the type. In an aspect, the database table can comprise a version number. For example, each version number can represent a version of the requested resource. In an aspect, each server from FIG. 50 can correspond to a version of the requested resource. For example, as shown in the database table in FIG. 50, computing device 4806a is associated with type “Main,” and the version of the requested resource associated with type “Main” is version number 3.2.2.

Although FIGS. 49-51 depict a particular set of database tables with a particular set of fields, more or fewer database tables could be used to accomplish the systems and methods described herein. Additionally, more or fewer database table fields could be used to accomplish the systems and methods described herein. Additionally, the fields described herein could be consolidated into fewer database tables and accomplish the systems and methods described herein. Additionally, the fields described herein could be expanded into more database tables and accomplish the systems and methods described herein. Additionally, the fields described herein could go by different column titles and accomplish the systems and methods described herein. Any database table and/or database table field arrangement used to accomplish the systems and methods described herein are contemplated.

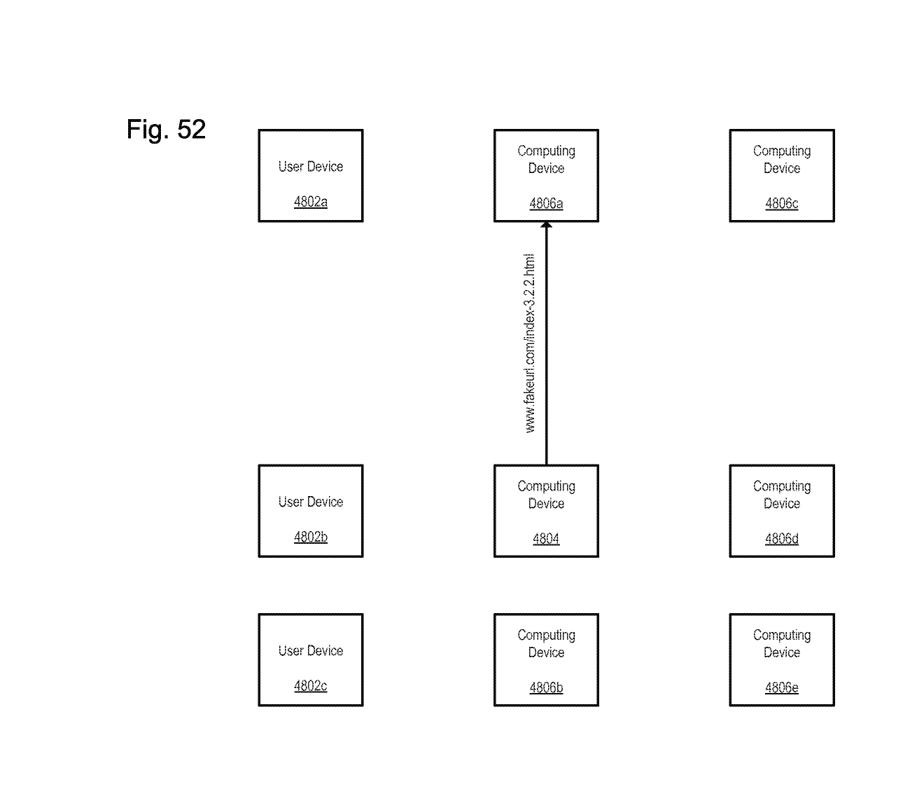

Turning now to FIG. 52, a block diagram is displayed. In an aspect, a request for a version of the requested resource is shown. In an aspect, in response to receiving the request for the resource from the user device 4802a, the first computing device 4804 can use the database table of FIG. 49 to determine a type to associate with the user authentication of the request. For example, the user authentication from the user device 4802a can comprise a login of “Bob” and a password of “Pass 1234.” The first computing device 4804 can then use the database table in FIG. 49 to retrieve a type (“Main”) associated with the user authentication and can relate user device 4802a with the retrieved type in the database table in FIG. 49. In an aspect, the type can be determined by one or more of a cookie, a token, a file, a set of data, and/or a pseudo-random assignment. The first computing device 4804 can then use the database tables of FIG. 50 and FIG. 51 to determine a server associated with a version number and associated with the determined type. In an aspect, the first computing device 4804 can route the request to a second computing device 4806a, 4806b, 4806c, 4806d, 4806e based on the determined version number. In the example, the first computing device 4804 can retrieve the version number (“3.2.2”) associated with the retrieved type (“Main”) and append the retrieved version number to the request. In an aspect, the request can be an HTML request. The second computing device 4806a can be at a location associated with “www.fakeurl.com/index-3.2.2.html.” The first computing device 4804 can transmit the request to the second computing device 4806a.

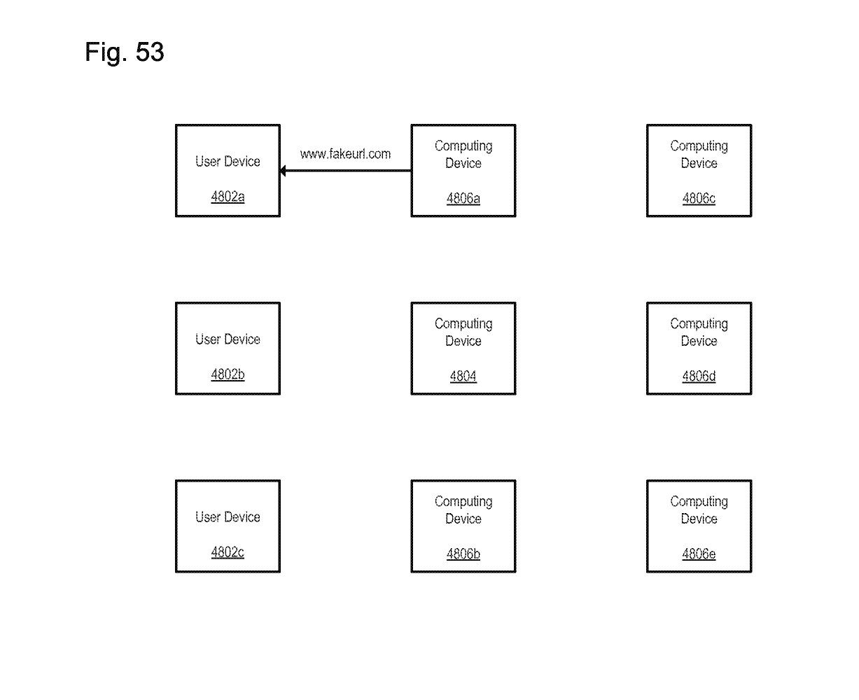

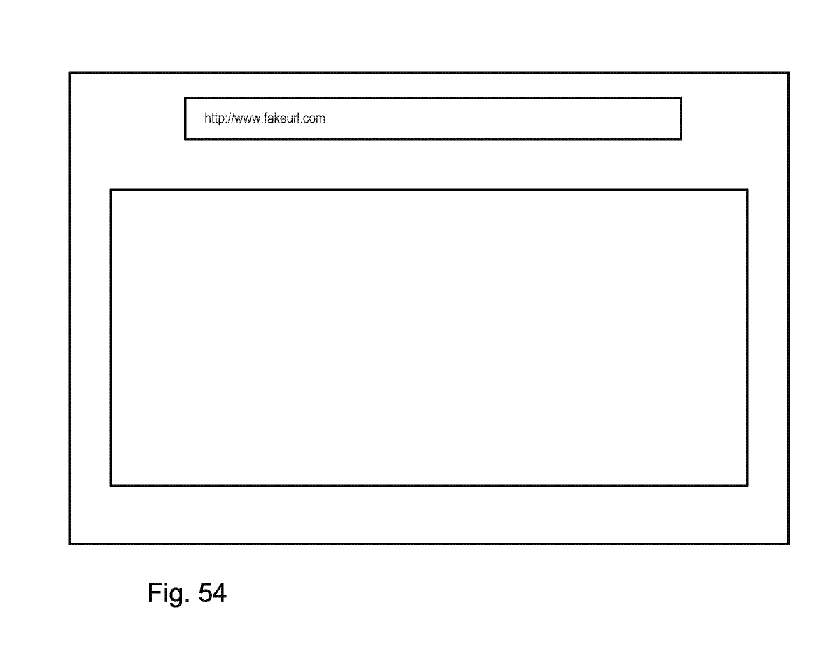

Turning now to FIG. 53, a block diagram is displayed. In an aspect, a version of the requested resource associated with the determined version number can be returned to the user device 4802a. In an aspect, the returned resource can appear versionless to the user device 4802a. This aspect is illustrated in the user interface illustrated in FIG. 54, where the resource in appears to be the requested resource, and not a particular version of the requested resource. For example, a user can type the uniform resource locator (“http://www.fakcurl.com”) into a web browser on the user device 4802a, transmit the request to the first computing device associated with the location of the resource 4804, and receive the version of the resource associated with the determined version number (“http://www.fakeurl.comindex-3.2.2.html”), and it will appear to the user device 4802a that the user device has received the requested resource (“http://www.fakeurl.com”).

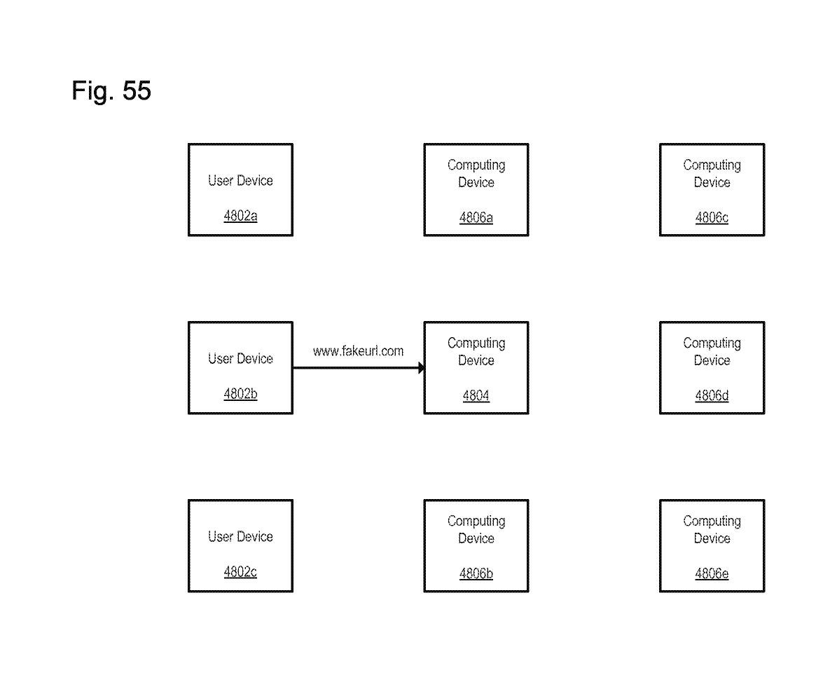

Turning now to FIG. 55, a block diagram is displayed. In an aspect, a user device 4802b can transmit a request for a resource (e.g., the URL “www.fakeurl.com”) to a first computing device 4804. In an aspect, the request for the resource can comprise a login of “Charles” and a password of “Pass 6789.” In an aspect, the first computing device 4804 can determine that a type associated with the request is “Preview.” In an aspect, one or more of the following can indicate a type of “Preview”: a cookie, a token, a file, a set of data, and/or a pseudo-random assignment. In an aspect, the first computing device 4804 can determine that a version number associated with the determined type of Preview is “3.2.4.”

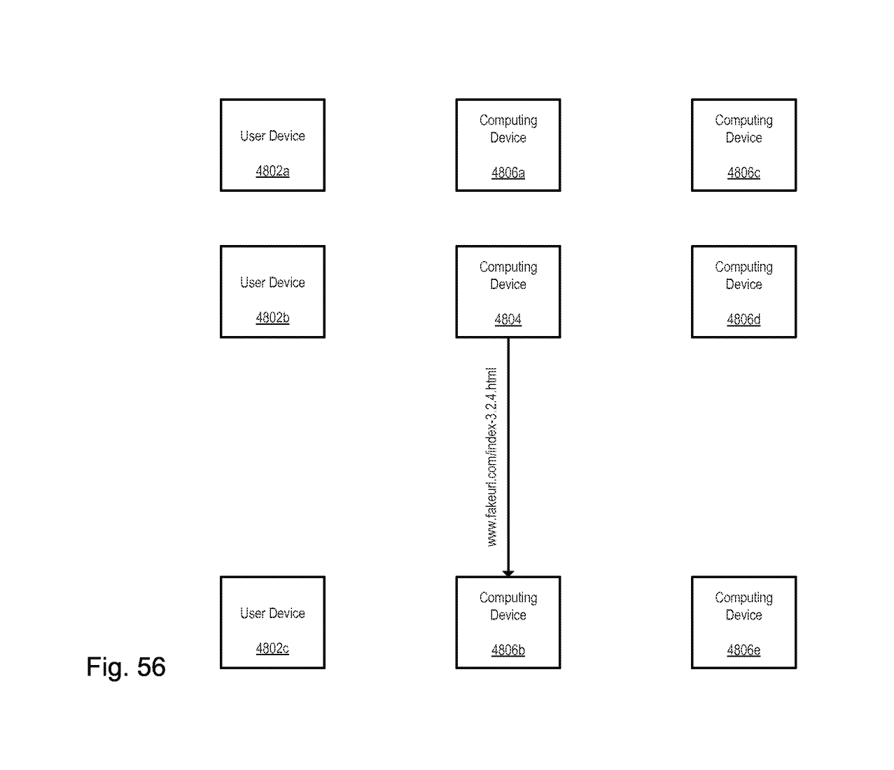

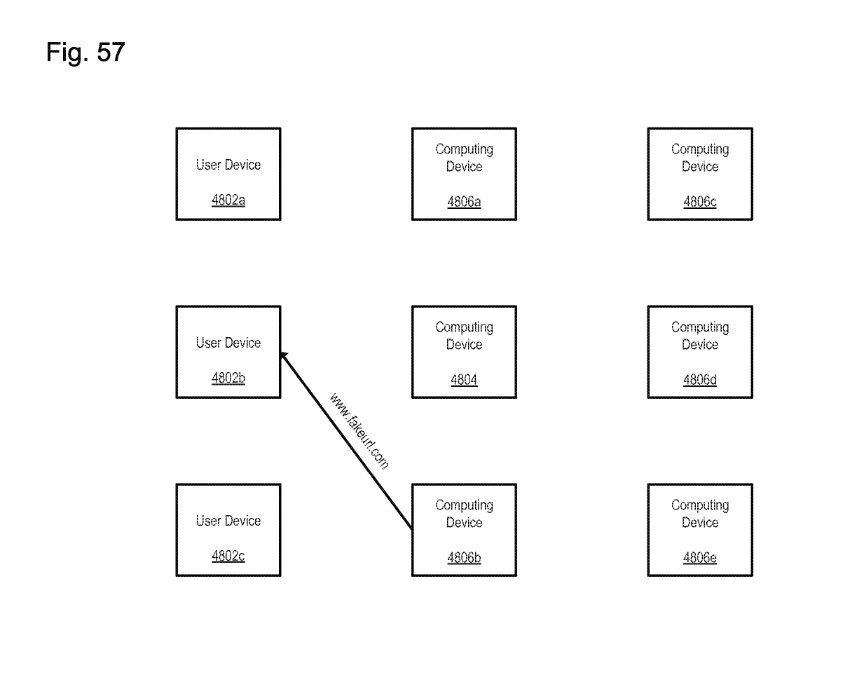

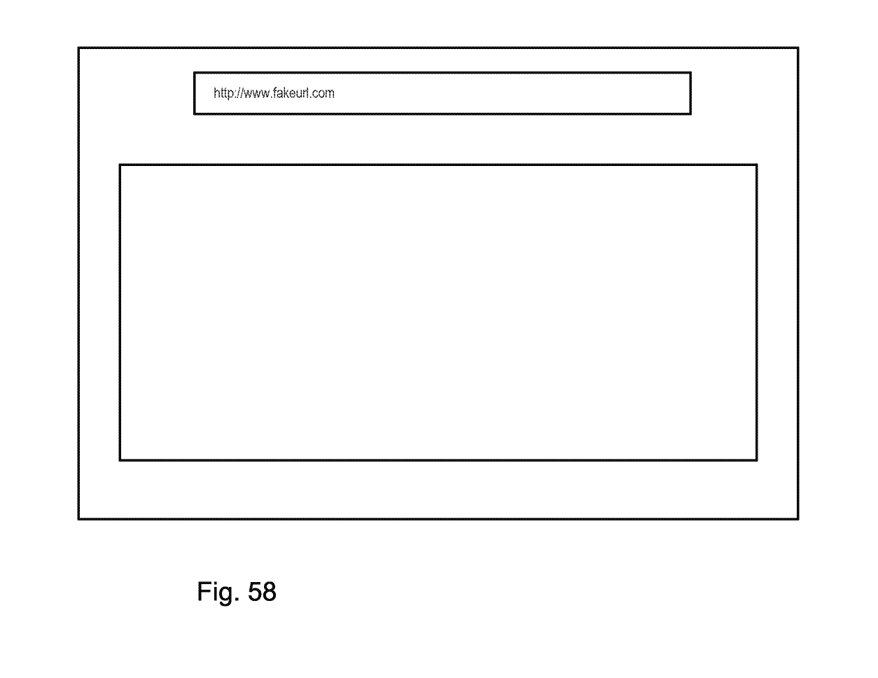

Turning now to FIG. 56, a block diagram is displayed. In an aspect, the first computing device 4804 can transmit the request to a second computing device 4806b associated with the determined version number. In an aspect, the first computing device 4804 can place the request in a queue and one or more second computing devices can compete to process the request. The first computing device 4804 can transmit the request to a winning second computing device 4806b of the one or more second computing devices. Turning now to FIG. 57, a block diagram is displayed. In an aspect, the second computing device 4806b can transmit a version of the requested resource associated with the determined version number to the user device 4802b. Turning now to FIG. 58, an exemplary user interface is illustrated. In an aspect, a web browser associated with the user device 4802b can display a versionless copy of the requested resource (“www.fakeurl.com”), even though the user device received the version of the resource associated with the determined version number (“www.fakeurl.com/index-3.2.4.html”).

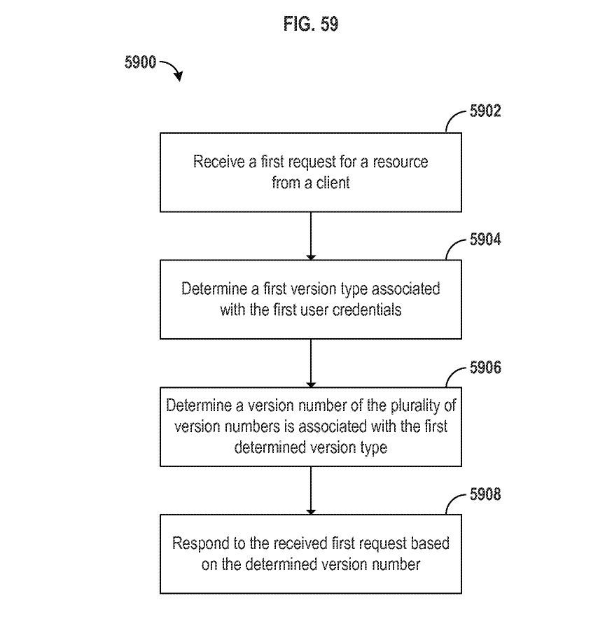

Turning now to FIG. 59, an exemplary flowchart 5900 is illustrated. At 5902, a first request for a resource can be received from a client device. In an aspect, the resource can be associated with a plurality of version numbers. In an aspect, the first request can comprise first user credentials. In an aspect, the client device can be a smart phone, tablet, laptop, desktop, or any other type of computing device. In an aspect, the resource can be a Hypertext Markup Language (HTML) file. In an aspect, the resource can be an application, such as a web-enabled application. In an aspect, the resource can be a website. In an aspect, the first user credentials can comprise a login, password, device identifier, any other user credential information, and/or any combination of the foregoing.

At 5904, a first version type can be determined to be associated with the first user credentials. For example, a login can be unique for each user and can have one corresponding type. In another example, a device identifier can be unique for each device and can have one corresponding type. At 5906, a version number of the plurality of version numbers can be determined to be associated with the first determined version type.

At 5908, the received first request can be responded to based on the determined version number. In an aspect, the response can further comprise retrieving a version of the requested resource associated with the determined version number. In an aspect, the response can further comprise transmitting the retrieved version of the requested resource to the client device, wherein the resource appears versionless to the client device. In an aspect, the response can further comprise routing the request to a server associated with the determined version number. In an aspect, the response can further comprise routing the request to a processor running a process associated with the determined version number.

Optionally, in an aspect, the client device can be caused to make a plurality of requests for a plurality of resources in response to the received first request. In an aspect, the plurality of resources can comprise one or more of a plurality of static resources and a plurality of dynamic resources. In an aspect, each of the plurality of static resources can be served with a cache expiration beyond a predetermined time. In an aspect, the determined version number can comprise an expected relevant time window. In an aspect, the predetermined time can be longer than the expected relevant time window. In an aspect, each of the plurality of dynamic resources can be served in a non-cacheable form.

Optionally, in an aspect, a time associated with the first request can be determined to exceed a predetermined time. In an aspect, a second request can be received. In an aspect, the second request can comprise second user credentials. In an aspect, a second version type can be determined to be associated with the second user credentials. In an aspect, the second version type can be determined to be the same as the first version type. In an aspect, the second request can be routed to a server. In an aspect, the server can be dedicated to requests exceeding the predetermined time.

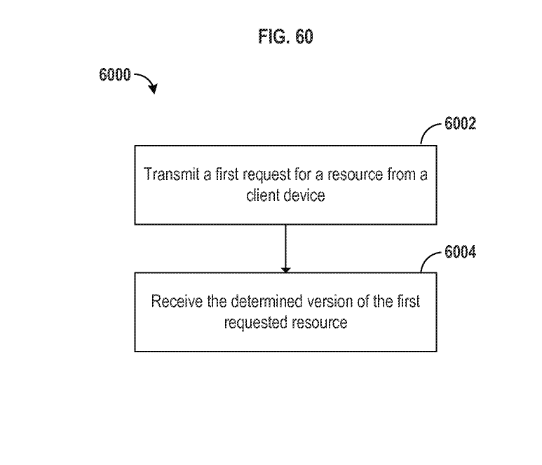

Turning now to FIG. 60, an exemplary flowchart 6000 is illustrated. At 6002, a first request for a resource can be transmitted from a client device. In an aspect, the first request can comprise first user credentials. In an aspect, a first type can be determined based on the first user credentials. In an aspect, a version of the resource can be determined based on the first determined type. In an aspect, the client device can be a smart phone, tablet, laptop, desktop, or any other type of computing device. In an aspect, the resource can be a Hypertext Markup Language (HTML) file. In an aspect, the resource can be an application, such as a web-enabled application. In an aspect, the resource can be a website. In an aspect, the first user credentials can comprise a login, password, device identifier, any other user credential information, and/or any combination of the foregoing. In an aspect, transmitting a first request for a resource from a client device can further comprise routing the first request to a server associated with the determined version. In an aspect, transmitting a first request for a resource from a client device can further comprise routing the first request to a processor running a process associated with the determined version. In an aspect, transmitting a first request for a resource from a client device can further comprise making a plurality of requests for a plurality of resources. In an aspect, the plurality of resources can comprise one or more of a plurality of static resources and a plurality of dynamic resources. In an aspect, transmitting a first request for a resource from a client device can further comprise receiving each of the plurality of static resources with a cache expiration beyond a predetermined time. In an aspect, the determined version can comprise a signature call, wherein the signature call comprises an expected relevant time window. In an aspect, the predetermined time can be longer than the expected relevant time window. In an aspect, a second request comprising the signature call can be received. The second request can be routed to a router that is not dedicated to processing requests expected to have a time longer than the predetermined time. In an aspect, a time associated with the second request can exceed a predetermined time. In an aspect, a third request comprising the signature call can be received. The third request can be routed to a router dedicated to processing requests expected to exceed the predetermined time. In an aspect, transmitting a first request for a resource from a client device can further comprise receiving each of the plurality of dynamic resources in a non-cacheable form. At 6004, the determined version of the first requested resource can be received. In an aspect, the resource can appear versionless to the client device.

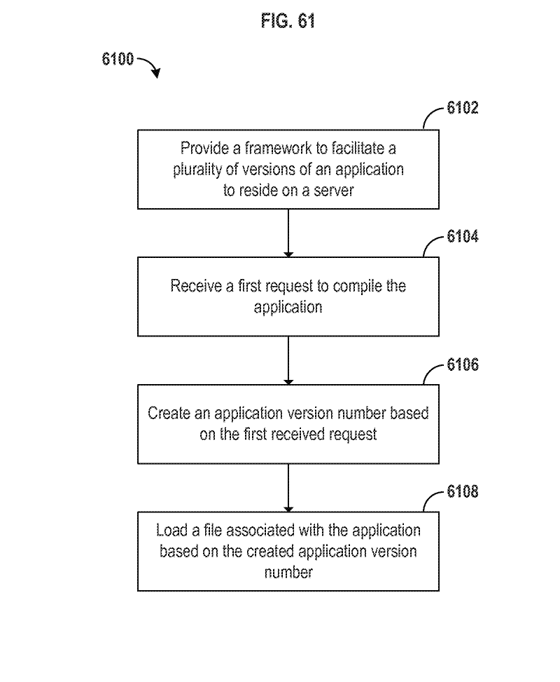

Turning now to FIG. 61, an exemplary flowchart 6100 is illustrated. At 6102, a framework can be provided to facilitate a plurality of versions of an application to reside on a server. In an aspect, each of the plurality of versions of the application can be associated with an application version number. At 6104, a first request to compile the application can be received. At 6106, an application version number can be created based on the first received request. In an aspect, the first received request can comprise the version number. In an aspect, creating an application version number based on the first received request can further comprise determining a latest number of the plurality of application version numbers. In an aspect, creating an application version number based on the first received request can further comprise incrementing the latest determined number. At 6108, a file associated with the application can be loaded based on the created application version number. In an aspect, a file name and a reference to the file can be updated based on the created version number.

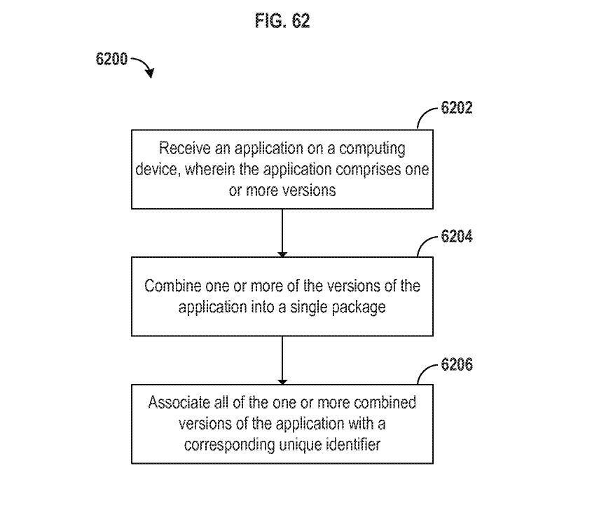

Turning now to FIG. 62, an exemplary flowchart 6200 is illustrated. At 6202, an application can be received on a computing device. In an aspect, the application can comprise one or more versions. In an aspect, the application can comprise one or more web packages. In an aspect, each of the one or more versions of the application can comprise a web package. At 6204, one or more of the versions of the application can be combined into a single package. In an aspect, the one or more of the versions of the application can be combined into the single package in response to a received request. In an aspect, each of the one or more versions of the application can be combined into the single package. At 6206, all of the one or more versions of the application combined into a single package can be associated with a corresponding unique identifier. In an aspect, the unique identifier can be determined by incrementing a previous identifier. In an aspect, the unique identifier can be determined by an assignment and/or argument passed to the program. Optionally, each of the unique identifiers can be associated with a version type. In an aspect, one of the unique identifiers can be updated to be associated with a new version type. Optionally, the single package can be provided. In an aspect, the single package can be provided to one or more servers. In an aspect, a first request for a first version of the one or more combined versions of the application can be received. In an aspect, the provided single package can be used to serve the requested first version in response to the first request. Optionally, combining one or more of the versions of the application into a single package can comprise combining two or more versions of the application into the single package. In an aspect, a second request for a second version of the one or more combined versions of the application can be received. In an aspect, the provided single package can be used to serve the requested second version in response to the second request.

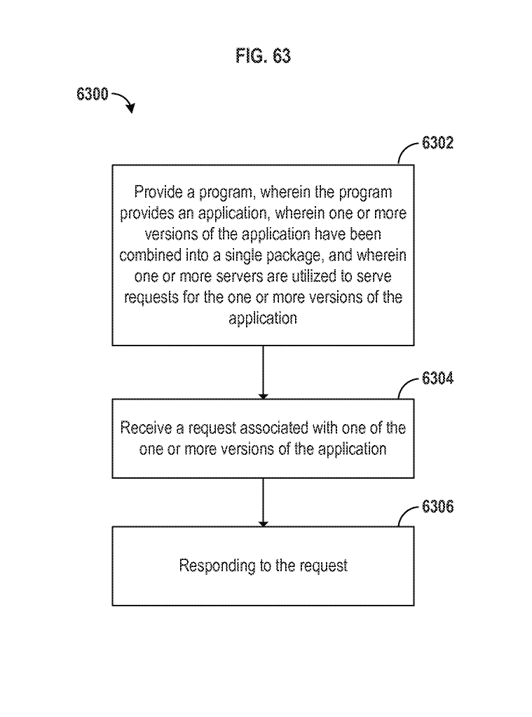

Turning now to FIG. 63, an exemplary flowchart 6300 is illustrated. At 6302, a program can be provided. In an aspect, the program can provide an application. In an aspect, one or more versions of the application can be combined into a single package. In an aspect, one or more servers can be utilized to serve requests for the one or more versions of the application. At 6304, a request associated with one of the one or more versions of the application can be received. In an aspect, the program can determine the one of the one or more versions of the application associated with the request. In an aspect, the program can determine the one of the one or more versions of the application associated with the request based on at least one of a cookie, a token, a file, a set of data, a user credential, and a pseudo-random assignment. At 6306, the request can be responded to. Optionally, responding to the request can comprise the program serving one or more resources associated with the one of the one of more versions of the application associated with the request. Optionally, the program can route the received request to one or more servers associated with the version of the application associated with the request. Optionally, the program can route the received request to one or more processors running a process associated with the version of the application associated with the request. Optionally, responding to the request can comprise transmitting the version of the application associated with the request to a client device, wherein the application appears versionless to the client device. Optionally, each of the one or more servers can comprise a role. In an aspect, a request signature can be determined for the received request. In an aspect, a role can be associated with the determined request signature. In an aspect, the received request can be routed to one of the one or more servers. In an aspect, the server can comprise the associated role. In an aspect, the server can be configured to serve the associated version of the application. Optionally, an expected response time can be determined associated with a process having the determined request signature. In an aspect, the determined expected response time can exceed a predetermined time threshold. In an aspect, the received request can be routed to a server comprising a role dedicated to processes having an expected response time that exceeds the predetermined time threshold. In an aspect, the determination of the expected response time is based on a configuration. Optionally, the determined expected response time may not exceed a predetermined time threshold. In an aspect, the received request can be routed to a server comprising a role dedicated to processes having an expected response time that does not exceed the predetermined time threshold. In an aspect, an actual response time associated with responding to the request can be determined. In an aspect, a determination can be made that the actual response time exceeds the predetermined time threshold. In an aspect, a configuration can be modified such that requests comprising the determined request signature will be routed to a server comprising a role dedicated to processes having an expected response time exceeding the predetermined time threshold. Optionally, the request can comprise a request for one or more static resources. In an aspect, responding to the request can comprise serving each of the one or more requested static resources with a cache expiration beyond a predetermined time. In an aspect, the predetermined time can be based on a boundary value. In an aspect, values exceeding the boundary value can be considered invalid. In an aspect, the cache expiration can cause the one or more static resources to be unchangeable until the predetermined time has elapsed.

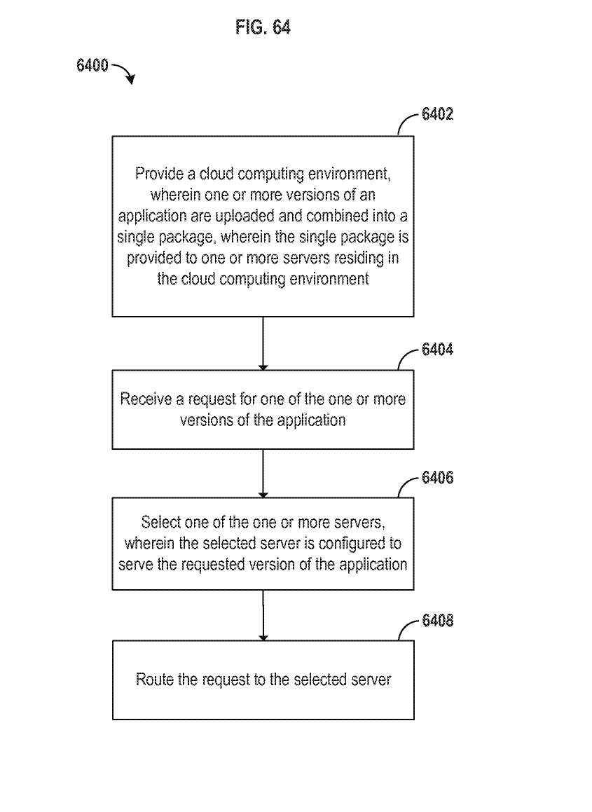

Turning now to FIG. 64, an exemplary flowchart 6400 is illustrated. At 6402, a cloud computing environment can be provided. In an aspect, one or more versions of an application can be uploaded and combined into a single package. In an aspect, the single package can be provided to one or more servers residing in the cloud computing environment. Optionally, the single package can comprise all files of the one or more versions of the application. Optionally, an identifier can be associated with each of the one or more versions of the application. Optionally, the identifier can be determined by incrementing a previous identifier. Optionally, the identifier can be determined by an assignment. Optionally, the identifier can be associated with a version type. Optionally, one of the identifiers can be updated to be associated with a new version type. At 6404, a request for one of the one or more versions of the application can be received. At 6406, one of the one or more servers can be selected. In an aspect, the selected server can be configured to serve the requested version of the application. Optionally, the single package can be used to serve any of the one or more versions of the application. At 6408, the request can be routed to the selected server.

Optionally, in an aspect, the created application version number can be associated with a particular version type. In an aspect, the created application version number can be associated with a server. In an aspect, the server can run the version of the application associated with the created application version number. In an aspect, a request for the application can be received from a client device. In an aspect, the first request can comprise user credentials. In an aspect, the user credentials can be determined to be associated with the particular version type. In another aspect, at least one of a cookie, a token, a file, a set of data, the user credentials, and/or a pseudo-random assignment can be determined to be associated with the particular version type. In an aspect, the particular version type can be determined to be associated with the created application version number. In an aspect, the version of the application associated with the created application version number can be transmitted to the client device. In an aspect, the application can appear versionless to the client device.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving an application on a computing device, wherein the application comprises one or more versions;
combining one or more of the one or more versions of the application into a single package; and
associating all of the one or more combined versions of the application in the single package to a corresponding unique identifier.

2. The method of claim 1, further comprising:
providing the single package, wherein a first request for a first version of the one or more combined versions of the application is received and wherein the provided single package is used to serve the requested first version in response to the first request.

3. The method of claim 2, wherein combining one or more of the one or more versions of the application into a single package further comprising:
combining two or more versions of the application into the single package, wherein a second request for a second version of the one or more combined versions of the application is received, and wherein the provided single package is used to serve the requested second version in response to the second request.

4. The method of claim 1, wherein combining one or more of the one or more versions of the application into a single package is in response to a received request.

5. The method of claim 1, wherein the unique identifier is determined by incrementing a previous identifier.

6. The method of claim 1, wherein the unique identifier is determined by an assignment.

7. The method of claim 1, further comprising:
associating all of the unique identifiers with a version type.

8. The method of claim 7, wherein one of the one or more unique identifiers is updated to be associated with a new version type.

9. The method of claim 1, wherein all of the one or more versions of the application are combined within the package.

10. A method comprising:
providing a program, wherein the program provides an application, wherein one or more versions of the application have been combined into a single package, and wherein one or more servers are utilized to serve requests for the one or more versions of the application;
receiving a request associated with one of the one or more versions of the application; and
responding to the request.

11. The method of claim 10, wherein the program determines the one of the one or more versions of the application associated with the request.

12. The method of claim 10, wherein the program determines the one of the one or more versions of the application associated with the request based on at least one of a cookie, a token, a file, a set of data, a user credential, and a pseudo-random assignment.

13. The method of claim 10, wherein responding to the request comprises the program serving one or more resources associated with the one of the one of more versions of the application associated with the request.

14. The method of claim 10, wherein the program routes the received request to one or more servers associated with the version of the application associated with the request.

15. The method of claim 10, wherein the program routes the received request to one or more processors running a process associated with the version of the application associated with the request.

16. The method of claim 10, wherein responding to the request further comprises transmitting the version of the application associated with the request to a client device, wherein the application appears versionless to the client device.

17. The method of claim 10, wherein each of the one or more servers comprises a role, further comprising:
determining a request signature for the received request;
associating a role with the determined request signature; and
routing the received request to one of the one or more servers, wherein the server comprises the associated role and wherein the server is configured to serve the associated version of the application.

18. The method of claim 17, further comprising determining an expected response time associated with a process having the determined request signature, wherein the determined expected response time exceeds a predetermined time threshold, and wherein the received request is routed to a server comprising a role dedicated to processes having an expected response time that exceeds the predetermined time threshold.

19. The method of claim 18, wherein determining an expected response time associated with a process having the determined request signature is based on a configuration.

20. The method of claim 17, further comprising:
determining an expected response time associated with a process having the determined request signature, wherein the determined expected response time does not exceed a predetermined time threshold, and wherein the received request is routed to a server comprising a role dedicated to processes having an expected response time that does not exceed the predetermined time threshold;
determining an actual response time associated with responding to the request;
determining that the actual response time exceeds the predetermined time threshold; and
modifying a configuration, such that requests comprising the determined request signature will be routed to a server comprising a role dedicated to processes having an expected response time exceeding the predetermined time threshold.

21. The method of claim 10, wherein the request comprises a request for one or more static resources, and wherein responding to the request further comprises serving each of the one or more requested static resources with a cache expiration beyond a predetermined time, wherein the predetermined time is based on a boundary value, wherein values exceeding the boundary value are considered invalid, and wherein the cache expiration causes the one or more static resources to be unchangeable until the predetermined time has elapsed.

22. A method comprising:
providing a cloud computing environment, wherein one or more versions of an application are uploaded and combined into a single package, wherein the single package is provided to one or more servers residing in the cloud computing environment;
receiving a request for one of the one or more versions of the application;
selecting one of the one or more servers, wherein the selected server is configured to serve the requested version of the application; and
routing the request to the selected server.

23. The method of claim 22, wherein the single package comprises all files of the one or more versions of the application.

24. The method of claim 22, wherein the single package is used to serve any of the one or more versions of the application.

25. The method of claim 22, wherein each of the one or more versions of the application is associated with an identifier.

26. The method of claim 25, wherein at least one of the identifiers is determined by incrementing a previous identifier.

27. The method of claim 25, wherein at least one of the identifiers is determined by an assignment.

28. The method of claim 25, further comprising associating at least one of the identifiers with a version type.

29. The method of claim 28, wherein the at least one of the identifiers is updated to be associated with a new version type.
